(19) United States
(12) Patent Application Publication
(10) Pub. No.: US 2026/0313051 A1
(43) Pub. Date: Oct. 8, 2026

(54) System and Method for Identity-Weighted Access Token Generation and Capability-Aware Delivery

(71) Applicant: TapText llc, Coral Springs, FL (US)

(72) Inventor: Steve Doumar, Fort Lauderdale, FL (US)

(21) Appl. No.: 19/705,642

(22) Filed: Jun. 11, 2026

Related U.S. Application Data
(63) Continuation-in-part of application No. 19/683,929, filed on May 21, 2026.
Application No. 19/683,929 is a continuation-in-part of application No. 19/441,824, filed on Jan. 6, 2026.
Application No. 19/441,824 is a continuation of application No. 17/874,209, filed on Jul. 26, 2022, now Pat. No. 12,519,888.
Application No. 17/874,209 is a continuation-in-part of application No. 17/865,814, filed on Jul. 15, 2022, now Pat. No. 12,211,070.
Application No. 17/865,814 is a continuation-in-part of application No. 17/229,251, filed on Apr. 13, 2021, now abandoned.
Application No. 17/229,251 is a continuation-in-part of application No. 17/209,474, filed on Mar. 23, 2021, now Pat. No. 11,599,916.
Application No. 17/209,474 is a continuation-in-part of application No. 17/208,059, filed on Mar. 22, 2021, now Pat. No. 11,562,407.
Application No. 17/208,059 is a continuation-in-part of application No. 17/191,977, filed on Mar. 4, 2021, now abandoned.
Application No. 17/191,977 is a continuation-in-part of application No. 17/190,260, filed on Mar. 2, 2021, now Pat. No. 11,532,020.
Application No. 17/190,260 is a continuation-in-part of application No. 17/153,426, filed on Jan. 20, 2021, now abandoned.
(63) Continuation-in-part of application No. 18/586,473, filed on Feb. 24, 2024.
Application No. 18/586,473 is a continuation-in-part of application No. 18/185,993, filed on Mar. 17, 2023, now Pat. No. 11,995,639.
Application No. 18/185,993 is a continuation of application No. 17/409,841, filed on Aug. 24, 2021, now Pat. No. 11,610,193.
Application No. 17/409,841 is a continuation-in-part of application No. 17/360,731, filed on Jun. 28, 2021, now Pat. No. 11,871,308.
Application No. 17/360,731 is a continuation-in-part of application No. 17/229,251, filed on Apr. 13, 2021, now abandoned.
Application No. 17/229,251 is a continuation-in-part of application No. 17/085,931, filed on Oct. 30, 2020, now Pat. No. 11,055,736.
(60) Provisional application No. 63/154,357, filed on Feb. 26, 2021.
(60) Provisional application No. 63/166,391, filed on Mar. 26, 2021.
(60) Provisional application No. 63/211,496, filed on Jun. 16, 2021.

(51) Int. Cl. H04M 3/51; H04L 51/02; H04M 1/72436

(52) U.S. Cl. CPC H04M 3/5191; H04L 51/02; H04M 1/72436

(57) ABSTRACT

A system and method for identity-weighted access token generation and capability-aware delivery, to dynamically adjust token parameters based on accumulated verification history and trust context. The system maintains longitudinal identity records that compound contextual intelligence across multiple verification events, computing identity confidence scores that weight token entropy, privilege levels, and temporal validity constraints. A multi-state opt-in model governs both messaging protocol eligibility and physical access entitlement tiers, enabling graduated consent progression from basic access to enhanced Rich Communication Services delivery to loyalty-augmented expedited entry. The system coordinates capability negotiation with consent-gated channel eligibility determination, maintaining seamless session continuity across protocol transitions when delivery failures occur. Enriched ledger entries record identity confidence scores, opt-in states, messaging protocols, and loyalty tiers alongside generated tokens, creating auditable trust evolution records that enable adaptive policy learning and differentiated access experiences for established users with proven engagement patterns.

### CROSS-REFERENCE TO RELATED APPLICATIONS

Priority is claimed in the application data sheet to the following patents or patent applications, each of which is expressly incorporated herein by reference in its entirety:
Ser. No. 19/683,929
Ser. No. 19/441,824
Ser. No. 17/874,209
Ser. No. 17/865,814
Ser. No. 17/229,251
63/166,391
Ser. No. 17/209,474
Ser. No. 17/208,059
Ser. No. 17/191,977
Ser. No. 17/190,260
Ser. No. 17/153,426
63/154,357
Ser. No. 18/586,473
Ser. No. 18/185,993
Ser. No. 17/409,841
Ser. No. 17/360,731
Ser. No. 17/229,251
Ser. No. 17/085,931
63/211,496

### BACKGROUND OF THE INVENTION

### Field of the Art

The present invention relates to the field of device and identity verification, and more specifically to verifying and contextualizing historic and current authorization and identity through mobile devices.

### Discussion of the State of the Art

Modern access control and identity verification systems face significant challenges in adapting to the accumulated trust context of individual users over time. Current systems treat each verification event as an isolated transaction, generating access tokens with fixed parameters determined solely by access rules configured at the time of event creation, without consideration of the user's verification history, engagement patterns, or demonstrated trustworthiness across prior interactions. This transactional approach results in functionally identical access tokens being issued to first-time users with no verification history and to established users with extensive proven engagement patterns, missing opportunities to provide differentiated experiences that reward trust while maintaining appropriate security postures for unknown or unverified identities. Furthermore, current systems lack persistent identity anchoring that enables the accumulation of contextual intelligence across multiple interactions, devices, sessions, and time periods. Phone numbers represent a stable and persistent identifier that could serve as an “identity DNA” anchor point, yet current systems fail to exploit this stability to build longitudinal identity profiles that compound in value and predictive power with each successive interaction.

Additionally, existing access control systems employ binary opt-in models that treat consent as a simple permitted-or-denied determination, rather than recognizing that users may progress through graduated consent states that unlock progressively enhanced capabilities and privileges. This binary approach fails to recognize that different users exhibit different levels of engagement commitment and verification willingness, and that these differences should inform both the messaging protocols available for communication with the user and the access privilege tiers granted upon successful verification. When enhanced messaging capabilities such as Rich Communication Services are available, existing systems either fail to utilize these capabilities entirely, or enable them uniformly for all users without gating access to enhanced features based on achieved consent levels or verification depth. Moreover, current systems lack dynamic token parameter adjustment based on accumulated identity confidence scoring, with access tokens encoding fixed privilege levels, entropy values, and temporal validity constraints determined by access rules rather than algorithmic adaptation based on the trustworthiness or verification depth of the specific user receiving the token.

Current systems additionally fail to maintain robust session continuity when messaging protocol transitions occur due to capability changes or delivery failures during active verification interactions. When a verification session is initiated using Rich Communication Services and a delivery failure subsequently occurs due to network disruption, device configuration change, or service unavailability, current systems typically abandon the session entirely and require the user to restart the verification process from the beginning. The failure to preserve session state, interaction history, token lineage, and attribution context across protocol transitions results in poor user experiences characterized by repeated information requests and session abandonment. Furthermore, existing systems do not record enriched metadata alongside access tokens in distributed ledgers or audit systems, with recorded entries typically comprising only basic token identifiers and timestamps without capturing the identity confidence scores, opt-in states, messaging protocols, or loyalty tiers that informed access control decisions.

What is needed is a system and method that generates identity-weighted access tokens whose parameters dynamically reflect the accumulated verification history and trust context of phone-number-anchored persistent identities, that implements multi-state opt-in models governing both messaging protocol eligibility and physical access privilege tiers, that coordinates Rich Communication Services capability negotiation with consent-gated channel eligibility determination, that maintains seamless session continuity and attribution across protocol transitions triggered by capability changes or delivery failures, and that records enriched trust metadata in distributed ledger entries to enable auditable trust evolution tracking and adaptive policy learning.

### SUMMARY OF THE INVENTION

Accordingly, the inventor has conceived and reduced to practice a system and method for identity-weighted access token generation and capability-aware delivery, to dynamically adjust token parameters based on accumulated verification history and trust context. The system maintains longitudinal identity records that compound contextual intelligence across multiple verification events, computing identity confidence scores that weight token entropy, privilege levels, and temporal validity constraints. A multi-state opt-in model governs both messaging protocol eligibility and physical access entitlement tiers, enabling graduated consent progression from basic access to enhanced Rich Communication Services (RCS) delivery to loyalty-augmented expedited entry. The system coordinates capability negotiation with consent-gated channel eligibility determination, maintaining seamless session continuity across protocol transitions when delivery failures occur. Enriched ledger entries record identity confidence scores, opt-in states, messaging protocols, and loyalty tiers alongside generated tokens, creating auditable trust evolution records that enable adaptive policy learning and differentiated access experiences for established users with proven engagement patterns.

According to a preferred embodiment, a system for identity-weighted access token generation and capability-aware delivery is disclosed, comprising: a mobile computing device comprising at least a first plurality of programming instructions stored in the memory of, and operating on at least one processor of, a first computing device, wherein the first plurality of programming instructions, when operating on the at least one processor, cause the first computing device to: interact with a near-field communication beacon or quick-response code initiator; transmit an auto-populated text message comprising a payload, an initiator identifier, and a phone number; and receive an identity-weighted access token via a messaging protocol; an interaction control server comprising at least a second plurality of programming instructions stored in the memory of, and operating on at least one processor of, a second computing device, wherein the second plurality of programming instructions, when operating on the at least one processor, cause the second computing device to: receive the transmitted text message comprising the phone number; query a phone-number identity database using the phone number as a primary key; retrieve an accumulated identity profile comprising interaction history and prior verification events if an existing profile is found, or initialize a new identity profile anchored to the phone number if no existing profile is found; apply inference logic to the identity profile to compute an identity confidence score reflecting depth and quality of verification history; evaluate a current opt-in state using a state machine comprising multiple discrete states governing messaging eligibility and access privilege levels; dynamically adjust token entropy and privilege level parameters based on the identity confidence score; generate the identity-weighted access token comprising a dynamically generated URL with adjusted entropic values and the adjusted privilege level; write an enriched entry to a distributed ledger comprising the generated token, the identity confidence score, a messaging protocol identifier, and the opt-in state; and transmit the identity-weighted access token to a messaging gateway for delivery to the mobile computing device; and a messaging gateway comprising at least a third plurality of programming instructions stored in the memory of, and operating on at least one processor of, a third computing device, wherein the third plurality of programming instructions, when operating on the at least one processor, cause the third computing device to: query a RCS capability endpoint using the phone number; receive a capability response indicating RCS support status; determine messaging protocol eligibility based on the opt-in state and the capability response; and deliver the identity-weighted access token to the mobile computing device using a selected messaging protocol.

According to another preferred embodiment, a method for identity-weighted access token generation and capability-aware delivery, comprising the steps of: interacting with a near-field communication beacon or quick-response code initiator, using a mobile computing device; transmitting an auto-populated text message comprising a payload, an initiator identifier, and a phone number, using a mobile computing device; receiving an identity-weighted access token via a messaging protocol, using a mobile computing device; receiving the transmitted text message comprising the phone number, using an interaction control server; querying a phone-number identity database using the phone number as a primary key, using an interaction control server; retrieving an accumulated identity profile comprising interaction history and prior verification events if an existing profile is found, or initialize a new identity profile anchored to the phone number if no existing profile is found, using an interaction control server; applying inference logic to the identity profile to compute an identity confidence score reflecting depth and quality of verification history, using an interaction control server; evaluating a current opt-in state using a state machine comprising multiple discrete states governing messaging eligibility and access privilege levels, using an interaction control server; dynamically adjusting token entropy and privilege level parameters based on the identity confidence score, using an interaction control server; generating the identity-weighted access token comprising a dynamically generated URL with adjusted entropic values and the adjusted privilege level, using an interaction control server; writing an enriched entry to a distributed ledger comprising the generated token, the identity confidence score, a messaging protocol identifier, and the opt-in state, using an interaction control server; transmitting the identity-weighted access token to a messaging gateway for delivery to the mobile computing device, using an interaction control server; querying a RCS capability endpoint using the phone number, using a messaging gateway; receiving a capability response indicating RCS support status, using a messaging gateway; determining messaging protocol eligibility based on the opt-in state and the capability response, using a messaging gateway; and delivering the identity-weighted access token to the mobile computing device using a selected messaging protocol, using a messaging gateway.

### BRIEF DESCRIPTION OF THE DRAWING FIGURES

FIG. 1 is a block diagram illustrating an exemplary system architecture for a dynamic-link verification platform.

FIG. 2 is a flow diagram illustrating an exemplary method for providing text-based link-initiated access control to an event or controlled physical location using a dynamic-link communication platform, according to an embodiment.

FIG. 3 is a system diagram illustrating a Rich Communication Services (RCS)-based lead redirection and opt-in management system.

FIG. 4 is a method diagram illustrating steps for opt-in-gated RCS channel eligibility determination and capability negotiation, according to an embodiment.

FIG. 5 is a method diagram illustrating steps for maintaining session continuity and seamless fallback during RCS to SMS channel transition, according to an embodiment.

FIG. 6 is a block diagram illustrating an exemplary system architecture for an identity-weighted token generation system, according to an embodiment.

FIG. 7 is a block diagram illustrating an exemplary system architecture for a consent-gated access level system, according to an embodiment.

FIG. 8 is a block diagram illustrating an exemplary system architecture for an RCS capability-aware token delivery system, according to an embodiment.

FIG. 9 is a method diagram illustrating steps for identity-weighted token generation using phone-number-anchored persistent identity as a determinative input to access token parameter selection, according to an embodiment.

FIG. 10 is a method diagram illustrating steps for consent-gated access level determination using a multi-state opt-in model to govern physical access entitlement, according to an embodiment.

FIG. 11 is a method diagram illustrating steps for maintaining session continuity and seamless protocol fallback during access token delivery when RCS capabilities become unavailable mid-verification, according to an embodiment.

FIG. 12 illustrates an exemplary computing environment on which an embodiment described herein may be implemented.

### DETAILED DESCRIPTION OF THE INVENTION

The inventor has conceived and reduced to practice, a system and method for identity-weighted access token generation and capability-aware delivery that uses phone-number-anchored persistent identity profiles to dynamically adjust access token parameters based on accumulated verification history and trust context. The system maintains longitudinal identity records that compound contextual intelligence across multiple verification events, computing identity confidence scores that inform token entropy, privilege levels, and temporal validity constraints. A multi-state opt-in model governs both messaging protocol eligibility and physical access entitlement tiers, enabling users to progress through graduated consent states that unlock progressively enhanced capabilities. The system coordinates Rich Communication Services (RCS) capability negotiation with consent-gated channel eligibility determination, maintaining seamless session continuity across protocol transitions when delivery failures occur due to network disruption or capability changes.

According to a first preferred embodiment, a system for identity-weighted access token generation is disclosed, comprising an interaction control server that receives initiator interactions from mobile devices and queries a phone-number identity database to retrieve or create persistent identity profiles anchored to phone numbers as primary identifiers. A trust scoring engine operates within the interaction control server to compute identity confidence scores by applying inference logic to accumulated identity data including interaction history, device associations, opt-in records, and engagement patterns. An opt-in state manager evaluates the current opt-in state of the user using a multi-state model comprising discrete consent levels that govern messaging eligibility and access privilege tiers. A token generator receives the identity confidence score, opt-in state parameters, and channel selection parameters, and generates an identity-weighted access token whose entropy, privilege level, and format dynamically reflect the combined inputs, such that users with rich verification histories receive tokens with elevated privilege parameters while users with minimal prior engagement receive tokens with more restrictive configurations. The token generator writes enriched entries to a distributed ledger comprising the generated token, identity confidence score, messaging protocol used for delivery, opt-in state, and loyalty tier, creating an auditable trust evolution record. A messaging gateway delivers the generated token to the mobile device using a protocol selected through coordination between a channel eligibility service and an RCS platform interface that negotiates capabilities with external RCS networks. An event host receives a tiered status notification reflecting the access privilege level encoded in the generated token and provides access to a controlled physical location upon token activation. According to a second preferred embodiment, a system for consent-gated access level determination is disclosed, comprising an interaction control server with an opt-in state manager that captures opt-in events triggered by user interactions with digital activation assets and maintains opt-in state information using a state-based model comprising State 0 representing no opt-in wherein no messaging is permitted, State 1 representing basic opt-in wherein standard messaging and basic access tokens are permitted, State 2 representing enhanced messaging opt-in wherein RCS delivery and enhanced access tokens are permitted, and State 3 representing verified identity and loyalty-confirmed opt-in wherein expedited entry and loyalty-augmented access privileges are available. An access entitlement resolver receives the current opt-in state and loyalty status information from a loyalty management server and produces a unified access entitlement parameter set that maps each opt-in state to a corresponding access privilege tier. A token generator receives the access entitlement parameter set and generates an access token whose privilege level, entropy, and format reflect the assigned entitlement tier, with the token delivered via messaging gateway using a protocol appropriate to the user's opt-in state and an event host receiving a tiered status notification reflecting the access privilege level.

According to a third preferred embodiment, a system for RCS capability-aware token delivery with session continuity is disclosed, comprising an interaction control server with a channel eligibility service that coordinates with an RCS platform interface of a messaging gateway to negotiate Rich Communication Services capabilities for a user's phone number by querying capability endpoints. The messaging gateway comprises a capability cache that stores previously retrieved RCS capability profiles, an RCS token renderer that formats access tokens for Rich Communication Services delivery with rich card layouts, interactive buttons, and branded sender identity, a Short Message Service (SMS)/Multimedia Messaging Service (MMS) fallback renderer that reformats tokens for SMS or MMS delivery by converting rich layouts to plain text and replacing interactive buttons with numbered reply options, and a session ID continuity service that associates a session identifier with outbound token delivery regardless of which renderer prepares the message. When RCS delivery is attempted and a failure is encountered due to device capability unavailability, service disruption, or network issues, a failure notification is sent to the interaction control server with the session identifier, enabling the system to retrieve session state and token lineage, automatically reformat the token for SMS or MMS delivery while maintaining the session identifier, and transmit the adapted token via the fallback protocol. User responses received via SMS are matched to the existing session despite the channel change, preserving full conversation context and enabling the session to continue via the alternative protocol or transition back to RCS if capability is restored, with complete session history preserved across all protocol transitions.

According to method embodiments, identity-weighted token generation comprises receiving an initiator interaction, querying an identity database using the phone number as primary key, retrieving or creating a phone-number-anchored identity profile, merging new contextual data into the profile, applying inference logic to compute an identity confidence score, dynamically adjusting token parameters based on the confidence score, generating an identity-weighted access token, writing an enriched ledger entry comprising token, confidence score, protocol, opt-in state, and loyalty tier, and delivering the token to the mobile device with a tiered status notification to an event host. Consent-gated access level determination comprises capturing an opt-in event, retrieving or creating a phone-number-anchored identity profile, evaluating the opt-in state to determine which of multiple discrete states applies, transmitting entitlement parameters to a token generator based on the determined state, generating an access token reflecting the assigned entitlement level, updating the identity profile, delivering the token using a protocol corresponding to the opt-in state, and sending a tiered status notification to an event host. Maintaining session continuity during protocol transitions comprises establishing an active RCS verification session with a session identifier, attempting RCS token delivery, receiving a failure notification if delivery fails, retrieving session state and token lineage using the session identifier, automatically reformatting the token for SMS or MMS delivery while maintaining the session identifier, delivering the adapted token via the alternative protocol, matching user responses to the existing session despite channel change, evaluating whether RCS capability has been restored and re-elevating the session if so, and preserving complete session history documenting all protocol transitions upon session termination.

One or more different aspects may be described in the present application. Further, for one or more of the aspects described herein, numerous alternative arrangements may be described; it should be appreciated that these are presented for illustrative purposes only and are not limiting of the aspects contained herein or the claims presented herein in any way. One or more of the arrangements may be widely applicable to numerous aspects, as may be readily apparent from the disclosure. In general, arrangements are described in sufficient detail to enable those skilled in the art to practice one or more of the aspects, and it should be appreciated that other arrangements may be utilized and that structural, logical, software, electrical and other changes may be made without departing from the scope of the particular aspects. Particular features of one or more of the aspects described herein may be described with reference to one or more particular aspects or figures that form a part of the present disclosure, and in which are shown, by way of illustration, specific arrangements of one or more of the aspects. It should be appreciated, however, that such features are not limited to usage in the one or more particular aspects or figures with reference to which they are described. The present disclosure is neither a literal description of all arrangements of one or more of the aspects nor a listing of features of one or more of the aspects that must be present in all arrangements.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects and in order to more fully illustrate one or more aspects. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method, or algorithm is carried out or executed. Some steps may be omitted in some aspects or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other aspects need not include the device itself.

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

### Conceptual Architecture

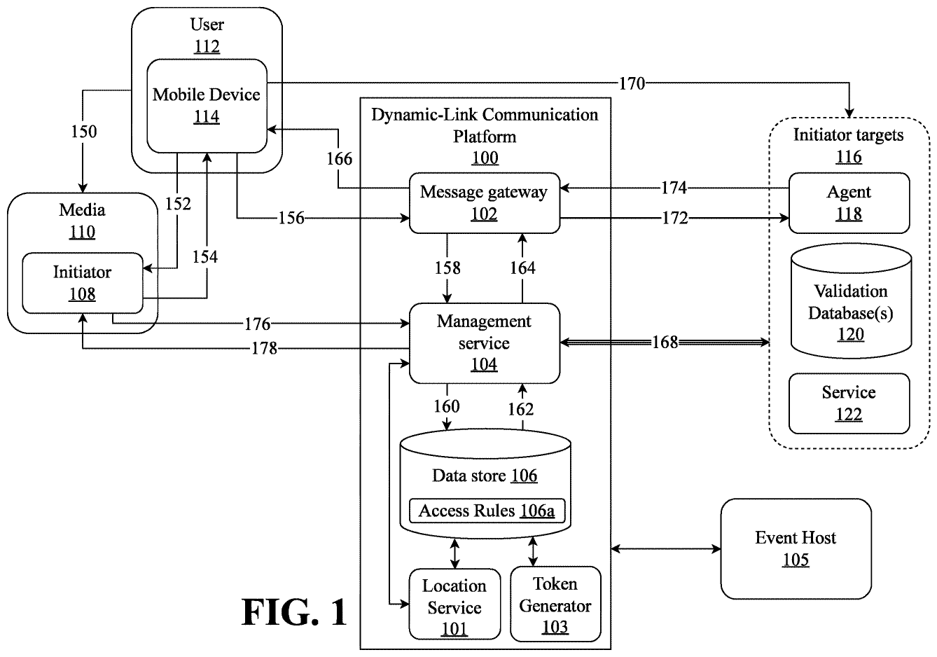

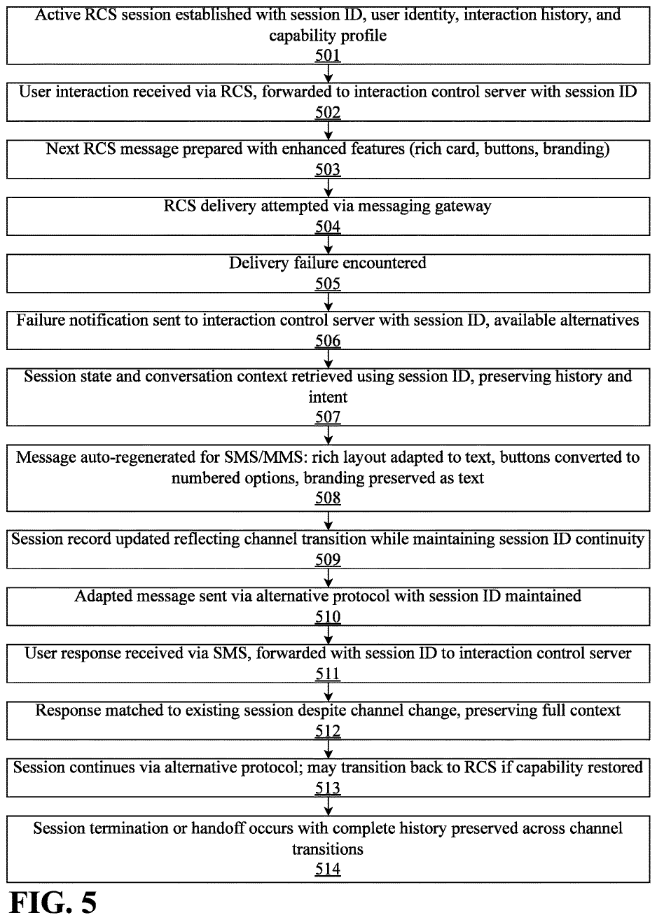

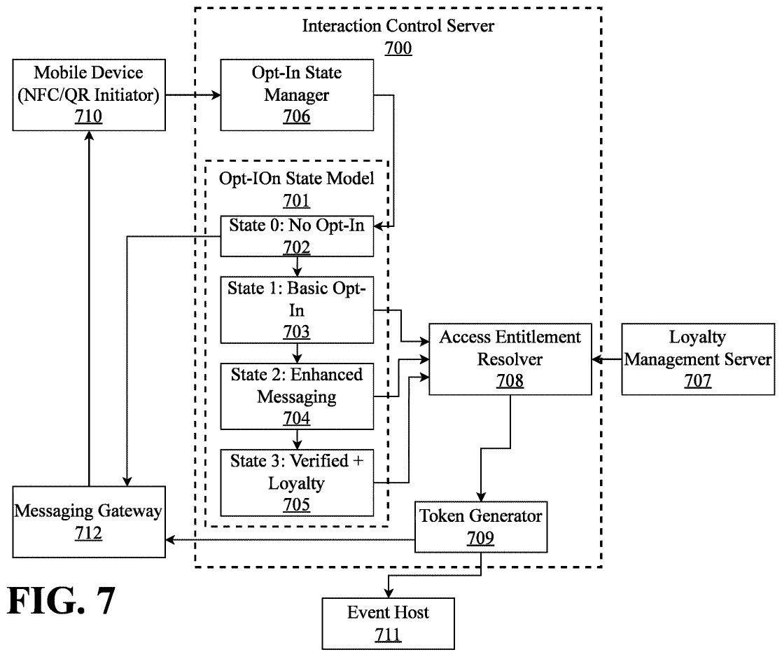

FIG. 1 is a block diagram illustrating an exemplary system architecture for a dynamic-link verification platform 100. A dynamic-link verification platform 100 functions in much the way of a dynamic-link communication platform 100 in FIG. 1. However, this embodiment of the system includes an event host 120, a location service 110, and a token generator 115. Additionally, data store 106 also access rules 105 which comprise access control instructions and access token parameters, according to various embodiments. In some embodiments, access rules 105 may be stored or otherwise logically linked to initiator targets 116 (referring to FIG. 5) and may be associated with products, services, and/or events. An event may have an initiator ID, rules, and/or content fields similar to those described above with respect to products 504, 508 and service 506. For example, an event may have an invitation that was sent out that contains an initiator 108 in the form of a QR code. In this example, the event would have a corresponding IID, set of rules (e.g., access rules, or exemplary rules 702-714, referring to FIG. 7), and/or content. According to an embodiment, access rules may comprise instructions for executing access control to an event or a controlled physical location, which may be implemented according to other rules and/or content available. Additionally, access rules may comprise information associated with an access token that can be generated upon request. For example, an event coordinator or creator could create an access rule or parameter that indicates an access token is required access the event or controlled physical location, and upload information that can be used by token generator 115 during the generation of the access token. In some implementations, access token information may comprise text, pictures, calendar and/or schedule data, audio data, video data, URLs, location parameters, time parameters, and information about which mode(s) of communication should be used to send a notification (e.g., a notification comprising the access token or some other information associated with the event or controlled physical location, etc.) to the user's 112 mobile device 114.

The embodiment includes one or more validation databases 1602 for use in authorizing individuals at business establishments, public parks and venues, and other places where authorization/validation may be utilized. In general, a user 112 attempts to conduct an ecommerce transaction or attempts to enter a controlled space. In both scenarios, an initiator 108 may be presented to the user 112 so that the mobile device 114 may interact with the initiator 108 whereby the initiator 108 triggers the mobile device 114 to auto-populate a text message relating to the ecommerce transaction or the request to gain entry into the controlled space. It is possible that more than one initiator 108 is present such as the case if there are multiple events at one venue, and other like-situations. The mobile device 114 sends the auto-populated text message and it is received by the message gateway 102. The text messages forwarded on to the management service 104 where the initiator ID is used to retrieve a rule relating to the e-commerce transaction or request for entry, or as defined hereafter a verification event. The rule contains instructions for the management service 104 to perform in order to verify the owner of the mobile device 114 and may further contain instructions for the creation of access tokens and/or providing access control. Rules may comprise various instructions, some of which are disclosed in the following examples.

An use case may be using a validation platform 100 to control entry into a public place, event, or venue based upon the condition that the individual has the appropriate vaccines. The management service 104 may reach out to a federated database comprising databases such as the CDC, hospital chains, etc. It may use the same local data store 106 and distributed ledger as mentioned previously. There may be multiple levels of validation depending on the context of the situation. For example, it is possible that a user has all of his or her vaccines and it is recorded as much in a database and upon a validation request, the user is verified as green, signifying that the user may attend the current and all future events contingent on the fact that the rules don't change regarding what vaccinations are required period. However, consider a second person who is also fully vaccinated but their vaccination information has yet to be uploaded to any database. This person may be manually verified by a person working the gate at a public event, such that after manual verification, the user's status may be stored in the local database 106 as yellow, signifying that they are only validated this one time and they must be validated again the next time they visit any establishment. It may be also that a user is not able to be manually or automatically verified according to their vaccination status, therefore a user 112 requesting to get in using their mobile device 114 and engaging with an initiator 108 would be denied entry and would be flagged as red signifying that they are not allowed entry into the event. The different verification levels—green, yellow, and red—may be used to print out wristbands of different colors, or provide different information in the form of a text message to the mobile device. The different statuses may be used to control what areas of the venue the person is allowed to be at. For example, at a restaurant, a user with a green status may be able to dine indoors while users with only a yellow status may only dine outdoors. With regards to providing different information in the form of a text message, keep in mind that the dynamic link verification platform 100 has the capabilities to store that information and provide it upon receiving the auto-populated text message from the mobile device 114, as disclosed in at least FIG. 1.

According to the embodiment, one or more event hosts 120 are present and configured to receive a status notification from dynamic-link communication platform 100. The status notification may indicate a confirmation of a user's (e.g., mobile device user) identity, an access token, a confirmation of access token generation, or some combination thereof. The event host 120 may then provide the verified user access to a controlled physical location based on retrieved access rules 105. For example, a person may create an initiator QR code embedded into an email which contains an invitation to birthday party in a gated community, wherein the person can create rules that govern who can access the party. The rules may determine who can access the controlled physical space, when they can access, how long they have access for, and on what conditions access may be granted. For example, the person who sends out the birthday invitations may create rules that indicate only verified invitees are allowed to the party, that invitees are only allowed to use certain entrances to the gated community, the time or range of time in which the invitees are granted access to the gated community, and finally the person who sent the invitations can indicate that access is only granted when the invitees are within a certain location relative to the allowed entrances to the gated community.

According to various embodiments, token generator 115 is configured to receive requests for creating access tokens, generate and store access tokens, and in some embodiments, communicate with user devices 114, requesting devices, and a gate, lock or other control device for providing access to a controlled physical location. In some embodiments, the event host 120 may be positioned remotely from the controlled physical location. In some implementations, a person associated with the event and/or controlled physical location may provide various event information corresponding to a particular guest access token to be generated. Additionally, or alternatively, information corresponding to a particular guest may be captured from the guest mobile device when the guest first interacts with the initiator 108. Token generator 115 can be configured to generate unique access tokens and corresponding notifications that can be sent to the user's mobile device 114 via message gateway 102 based on access rules.

Furthermore, the request for an access token may comprise one or more access rules which can be used by token generator 115 to generate the access token. The access rules 105 may include, but are not limited to, a time element or parameter, a location element or parameter, and/or a method or mode of delivering the access token to the verified user. For example, the time element may be defined by one or more of an arrival time, a departure time, and/or a range of time window. The location element may be used to define the location parameter of the access token. In some implementations, the location elements and/or parameters may be predefined, for example, based upon the event host's profile. As an example, the requesting party may only have privileges to request an access token for a particular location, including, for example, the particular community where the birthday party is located. Other embodiments allow the event creator to define the location element. In some embodiments, the event host can specify the mode of delivering the notification to the user 112 that an access token is available for viewing, retrieval, or activation. Some exemplary modes include, but are not limited to, SMS, email, and social media.

Once a user is verified, dynamic-link communication platform 100 can submit a request to create an access token. Token generator 115 will receive the request and generate the access token based at least in part upon the event information available (e.g., content and rules, time parameter, location parameter, mode of delivery, etc.). In some embodiments, the access token may comprise a compilation or set of information, data, and parameters (e.g., guest name, IID, device key, device ID, etc.), event information (e.g., purpose, location, time, etc.) as well as a verified guest ID. The access token may be stored in a database or other storage device and provided to the verified mobile device user 112, for example, in the form of a dynamically generated HTML document. Furthermore, in some implementations, generating the access token may also include generating a unique notification value or uniform resource locator (URL) and associating the notification value or URL with the access token. Systems and methods that are used to automate passwords, for example, may be used to generate at least a portion of the entropic or unique URL of a least one embodiment.

This embodiment of dynamic-link communication platform 100 comprises a location service 110 which includes hardware and software to determine the location of the user mobile device 114. The location service 110 may be leveraged to provide remote access control to physical locations or events via access tokens associated with location based access control rules. Depending on the implementation of an embodiment, the location service may determine the absolute and/or relative location of the device. The absolute location may be determined by using a global position satellite (GPS) receiver that is integrated into the device, which can be used to determine the approximate longitude and latitude of the device. Another method of determining the absolute location is through the use of a network-based position-location system, which may use, for example, triangulation from cell towers to locate the device. In some embodiments, the location data may be transmitted to the system from an external system (e.g., network based position location system) capable of determining its location.

Absolute location data may also be transmitted from a nearby device (e.g., airplane, bus, automobile, etc.), which itself has a means for determining its absolute location or transmitted from a nearby device that is fixed in location and that has absolute location data pre-stored therein (e.g., via WLAN from an access point in a billboard, a road side sign with an initiator, a vendor, etc.). Additionally, data in periodic transmissions or in a single transmission from a fixed device could be used with velocity data supplied by a vehicle to determine an accurate and substantially continuous absolute location of a device carried in a moving vehicle (i.e., a mobile user on their way to a controlled physical location).

The location data may be used with map data stored in memory of the device 114, or stored in a computer system with which device 114 communicates to provide a real world location (e.g., street, intersection, address, complex, business, etc.) as is well-known in the art.

The relative location refers to the location of the device 114 relative to another point of interest such as the distance (or time) from a particular point of interest. For example, in some implementations, it may be necessary to find the closest vender of a given product. In doing so, the relative location of the device 114 from each vender is compared to find the closest vender. The relative location to a controlled physical location can be determined from the absolute locations of the device 114 and the controlled physical location. In some implementations, a communication link with a particular access point and/or event host 120 may provide relative location data to location service 110 or an external computer system.

The relative location may also be determined from data transmitted from nearby devices (e.g., via WLAN from an access point in a billboard, a road sign with an initiator, a vender, etc.) that includes information of the relative location of the nearby device 114. For example, the nearby device may transmit information to the device 114 to indicate that the device is at, or within, a predetermined distance to a particular controlled physical location (e.g., concert, vender, vacation home, storage box at a public park, etc.). Alternatively, the nearby device can transmit the distances from the nearby device to a plurality of controlled physical locations when the communication link with the device 114 is established.

In operation, the event host receives a confirmation of the mobile device 114 user's identity and can then permit access to the controlled physical location based on the event creator's established rules, if applicable. In some implementations, event host 120 may include a token generator which can be configured to generate unique access tokens and corresponding notifications that can be sent to the user's mobile device 114 via message gateway 102. The generated tokens correspond to an event guest's mobile device and are only usable by verified individuals. For example, once an initiator is created (e.g., a birthday invitation), it may be sent to the birthday guests via SMS or email wherein interacting with the initiator causes an auto-populated text message to appear in the default messaging application on the mobile device, which when sent by the mobile device owner causes the mobile device owner to have their identity confirmed. Once confirmed, the mobile device user can receive another text message or email which comprises a unique link to a webpage or some other form of unique access token. When the guest is within a proximate location or defined vicinity to the gated community entrance (or the guest is within a certain time period, or some other defined condition or rule is satisfied), the guest can open the webpage and activate and open the gate to the community. In some implementations, the system may only validate the access token if activated by a particular authorized mobile device, phone number, or device. In addition, at least one embodiment may include a one-time pass, meaning that the token or invitation may only be activated a single time. Thus the system is useful because it provides a system and method for verifying entry credentials and activating/deactivating an access control system via the use of a mobile device to permit access to a controlled physical location.

The event host may be a computing device or computer system capable of storing machine readable instructions in a memory or data storage device and possessing one or more processors capable of executing said machine readable instructions to perform various task disclosed herein. The event host may further have the ability to connect to a network (e.g., WiFi, LAN, etc.) and communicate with other devices and systems such as dynamic-link communication platform 100 and/or a user's mobile device 114. Preferably, location service includes a GPS receiver with mapping software. In addition, relative location data cab be determined from the device's communications with access points that form part of a WLAN.

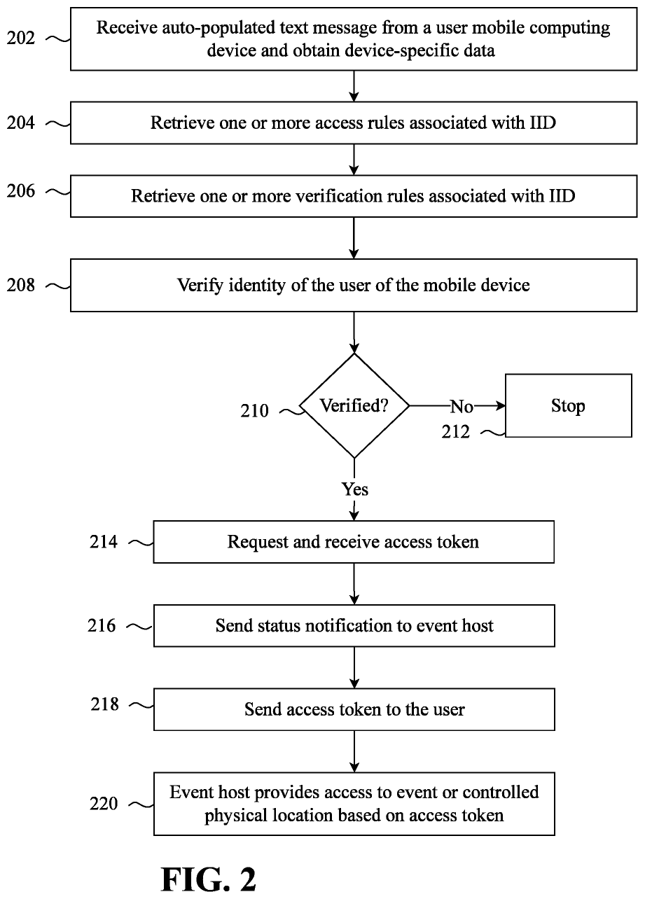

FIG. 2 is a flow diagram illustrating an exemplary method for providing text-based link-initiated access control to an event or controlled physical location using a dynamic-link communication platform 100, according to an embodiment. According to the embodiment, the process begins at step 202 when platform 100 receives the auto-populated text message from a user 112 mobile computing device 114 and at this step may also obtain device-specific data associated with the user's mobile computing device. As a next step, management service 104 may retrieve one or more access rules 204 and one or more verification rules 206 associated with IID which was associated with the auto-populated text message. The rules may be retrieved from data store 106 or similar data storage system. The verification rules may be used to verify the identity of user of the mobile device at step 208 by querying one or more databases for information confirming the identity of the owner of the mobile device. A check is made at 210 whether the user is verified or not. If not, then the process stops at step 212. Otherwise, if the user is verified, then the process proceeds to step 214 wherein a request for an access token is sent to token generator 115, which in turn generates an access token based on the retrieved access rules which were included in the request for an access token. At step 216 a status notification is sent to an event host, wherein the status notification may comprise a confirmation of the user of the mobile device identity, the generated access token, and other information that may be associated with the event, user, and/or controlled physical location. At step 218 the generated access token is sent to the user 112 via message gateway 102. At step 220 the event host provides access to the event or controlled physical location based on the access token presented by the user as well as with respect to any access rules that may be associated with the event or controlled physical location. For instance, the access token may provide access to a private reserved tennis court when the user activates the access token using his or her mobile device. For example, the tennis court may have a smart lock that is configured to allow only certain devices to connect with the smart lock to open and close, and the access token provides the smart lock with user device authentication thereby allowing the user to access the tennis courts with the use of their mobile device.

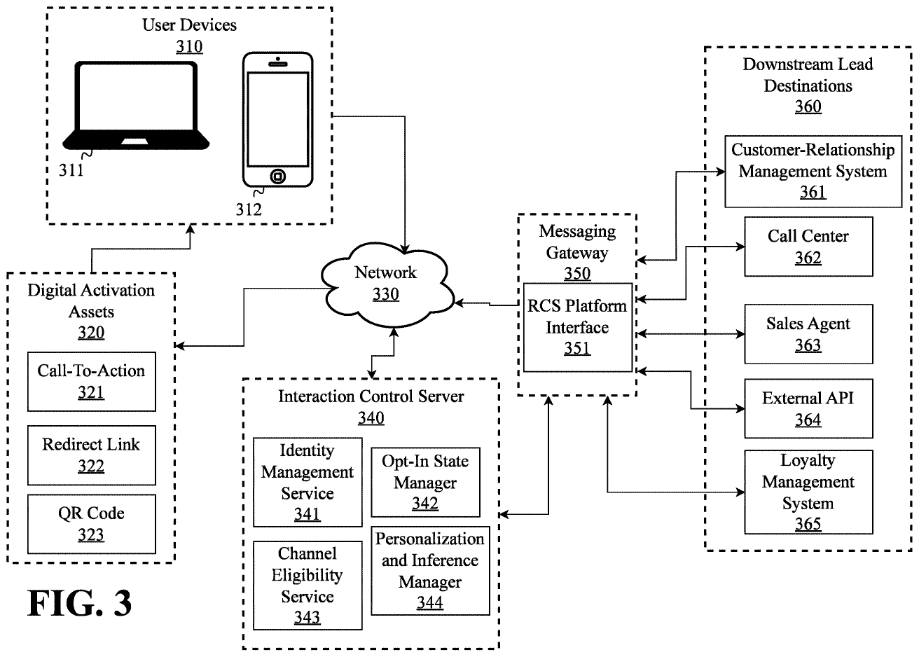

FIG. 3 is a system diagram illustrating an RCS-based lead redirection and opt-in management system using phone-number-centric identity and verified messaging channels, with detailed sub-components for identity management, opt-in state management, channel eligibility determination, and personalization, according to an embodiment.

According to the embodiment, the system comprises user devices 310, which may include a laptop or desktop computer 311 and a mobile device 312 such as a smartphone or tablet, or other user devices as may become available in the future, if they are capable of communications with other networked devices. User devices 310 are configured to interact with digital activation assets 320 over a network 330 and are further configured to receive and display messages delivered via multiple messaging protocols, to transmit interaction signals and user responses to the system, and to execute user interactions including tapping, clicking, scanning, or otherwise using digital activation assets. User devices 310 may have varying communication capabilities including support for SMS, MMS, RCS, email, or web-based communication, and may provide device-identifying information such as phone numbers, email addresses, device identifiers, platform information, and messaging client capabilities that enable the system to establish user identity and determine appropriate communication protocols.

Digital activation assets 320 may comprise various trigger mechanisms including a call-to-action button 321, a redirect link 322, and a QR code 323, each of which may be embedded in advertisements, web pages, physical media, or messages to initiate user engagement with the system. Digital activation assets 320 are configured to be delivered to user devices 310 through multiple channels and formats, to encode campaign identifiers, product or service information, or opt-in context, and to generate interaction signals when accessed or activated by users. The digital activation assets 320 may be format-agnostic and capable of being delivered via email, SMS, MMS, RCS messages, web pages, or embedded within other digital content, with presentation and functionality adapting to the capabilities of the receiving user device 310 and the communication protocol used for delivery.

The network 330 may comprise one or more communication networks including the Internet, cellular networks, packet-switched data networks, or other network infrastructure capable of transmitting data between components of the system. Network 330 is configured to support bidirectional communication between user devices 310, messaging gateway 350, and interaction control server 340, to transmit messages using multiple protocols including SMS, MMS, RCS, email, and web-based communication, and to convey interaction signals, user responses, contextual metadata, device capabilities, and protocol information between system components.

User devices 310 communicate with an interaction control server 340 via network 330 and messaging gateway 350, wherein the interaction control server 340 operates to manage opt-in events, determine messaging channel eligibility, coordinate session state, and control lead redirection operations as described in various embodiments herein. According to the embodiment, the interaction control server 340 comprises multiple sub-components or integrated services that collectively provide identity management, opt-in state management, channel eligibility determination, and personalization capabilities.

The interaction control server 340 comprises an identity management service 341, which is configured to maintain persistent user identity profiles anchored to phone numbers as primary identifiers, to store and manage identity records comprising interaction history, device associations, communication preferences, opt-in records, engagement patterns, and accumulated contextual observations, to resolve user identity from phone numbers, email addresses, device identifiers, or other identifying information received during interactions, to merge new contextual data with existing identity profiles upon each user interaction, to enrich identity profiles with inferred preferences and behavioral patterns derived from accumulated data, and to provide identity data to other components of the interaction control server 340 and to downstream lead destinations 360 subject to opt-in scope and privacy constraints. The identity management service 341 treats phone numbers as identity DNA, creating a stable anchor for persistent user identification across devices, channels, sessions, and time periods, enabling the accumulation of contextual intelligence that compounds with each interaction.

The interaction control server 340 further comprises an opt-in state manager 342, which is configured to capture and record opt-in events triggered by user interactions with digital activation assets 320, to maintain opt-in state information using a state-based model rather than binary permission flags, to associate opt-in events with contextual metadata including activation asset identifiers, campaign parameters, timestamps, device characteristics, and consent scope parameters, to manage multiple opt-in states indicating different levels or types of messaging eligibility including no opt-in, basic messaging permission, enhanced messaging capability permission, and verified or branded messaging context permission, to enforce state transitions in response to user actions, elapsed time, campaign context changes, or external verification processes, to consult opt-in state when determining whether messages may be sent and which messaging protocols and features may be enabled, to log and retain opt-in events and state transitions for audit, reporting, and compliance purposes, and to provide opt-in state information to channel eligibility service 343 and other components for use in downstream processing decisions.

The interaction control server 340 further comprises a channel eligibility service 343, which is configured to determine which messaging channels and protocols are eligible for use in a given interaction based on evaluation of opt-in state from opt-in state manager 342, device capabilities, carrier enablement, platform support, business verification status, and campaign configuration, to evaluate channel eligibility as a distinct processing step occurring after opt-in capture and prior to message delivery, to conditionally enable enhanced messaging capabilities including RCS only when eligibility criteria are satisfied, to apply prioritization rules when multiple channels are eligible to select a preferred protocol based on feature richness, expected user experience, reliability, or prior interaction history, to dynamically reevaluate eligibility over time or across interaction steps in response to user actions, changes in device or platform configuration, completion of verification processes, or elapsed time, to communicate with RCS platform interface 351 to negotiate and retrieve RCS capability information, to maintain capability cache storing previously retrieved capability profiles associated with devices, users, or messaging identifiers, to select fallback messaging protocols when enhanced capabilities are unavailable while preserving interaction continuity and attribution, and to provide channel and protocol selection decisions to messaging gateway 350 for message delivery.

The interaction control server 340 further comprises a personalization and inference manager 344, which is configured to apply inference logic and machine learning algorithms to accumulated identity data to derive implicit user preferences without requiring explicit confirmation, to analyze interaction patterns across time to infer preferred communication times, preferred devices, preferred protocols, and product or service interests, to generate behavioral models predicting user engagement propensity and responsiveness, to continuously refine understanding of user preferences and behavior patterns with each new interaction using phone number as stable identity anchor, to create compounding intelligence that improves personalization and targeting effectiveness over time, to determine optimal future contact strategies including protocol selection, timing, device targeting, and message personalization based on accumulated intelligence, to provide personalization recommendations to channel eligibility service 343 and identity management service 341 for use in message preparation and delivery, to generate enriched user context for transmission to downstream lead destinations 360, and to enable progressively improving engagement experiences with reduced friction as the system accumulates more data about each user identity. The personalization and inference manager 344 may utilize artificial intelligence, machine learning, natural language processing, behavioral analytics, or other computational intelligence techniques to extract insights from accumulated interaction data and to optimize engagement strategies dynamically.

Interaction control server 340 is further configured to receive and process digital activation asset interactions forwarded from messaging gateway 350, to determine user identity and communication preferences using contextual data including device type, platform information, messaging protocol used, and historical interaction patterns by coordinating between identity management service 341, opt-in state manager 342, channel eligibility service 343, and personalization and inference manager 344, to maintain persistent user identity profiles associated with phone numbers or other identifiers, to accumulate and update contextual information about users over time without requiring repeated explicit confirmation, to select appropriate messaging protocols and communication methods for future interactions based on accumulated context and implicit preferences, to generate and format data for transmission to downstream lead destinations 360 using preferred or preconfigured formatting or data transmission methods such as proprietary APIs or generalized JSON objects, and to enable frictionless future communications by automatically routing messages over preferred communication media and protocols to preferred devices using all available context.

A messaging gateway 350 is communicatively coupled to both the interaction control server 340 and the network 330. The messaging gateway 350 may be communicatively coupled to the interaction control server 340 through various architectural configurations, including: as a directly coupled component wherein messaging gateway 350 and interaction control server 340 are integrated within the same computing system or physically co-located hardware; as a sub-component wherein messaging gateway 350 operates as a functional software application or service, or physical device such as an ASIC or specialized chip, within interaction control server 340, or vice versa; through direct on-premises connection wherein messaging gateway 350 and interaction control server 340 are separate physical devices connected via local area network, direct physical connection, or other on-premises infrastructure; or through network-based connection wherein messaging gateway 350 and interaction control server 340 are decoupled and communicate over one or more networks 330 including the Internet, wide area networks, or other remote communication infrastructure. Regardless of the specific coupling architecture employed, messaging gateway 350 and interaction control server 340 are configured to exchange data bidirectionally to coordinate messaging operations, channel selection, and interaction processing.

The messaging gateway 350 comprises an RCS platform interface 351, which is configured to communicate with external RCS platform services, carrier RCS networks, and RCS business messaging providers, to negotiate RCS capabilities for specific phone numbers or devices by querying capability endpoints or retrieving capability information from platform services, to retrieve capability profiles indicating supported RCS features including rich cards, interactive buttons, suggested replies, rich media, branded sender identity, persistent sessions, and any feature limitations or restrictions, to verify business sender status and retrieve verified identity information including registered business names, brand logos, and verification badges, to transmit RCS messages with appropriate formatting, branding, and interactive elements based on negotiated capabilities, to receive RCS message delivery confirmations, read receipts, and user interaction events, to detect RCS delivery failures or capability unavailability conditions, and to provide capability information and delivery status to channel eligibility service 343 within interaction control server 340 for use in eligibility determination and fallback decisions. The RCS platform interface 351 enables the messaging gateway 350 to leverage enhanced RCS features when available while maintaining robust fallback capabilities when RCS is unsupported or unavailable.

Messaging gateway 350 is configured to support multiple messaging protocols including Rich Communication Services (RCS), Short Message Service (SMS), and Multimedia Messaging Service (MMS), and operates to transmit messages to user devices 310 and receive inbound user responses based on channel eligibility determinations and capability negotiations performed by interaction control server 340 through coordination between channel eligibility service 343 and RCS platform interface 351. Messaging gateway 350 is further configured to receive digital activation assets from interaction control server 340 for delivery to users, to determine messaging protocol and methodology to use for each user based on user signup contact information and device capabilities in coordination with channel eligibility service 343, to deliver digital activation assets to user devices 310 in formats appropriate to the selected protocol and receiving device, to receive digital activation asset interactions from user devices 310 including URL accesses from referral links, data from QR code scans, button presses, or other user-initiated actions, to capture and forward interaction events along with contextual metadata to interaction control server 340, to transmit comprehensive contextual data including the interaction content, messaging protocol used, device type, platform information, carrier network, geographic or network location data, timestamp information, and any other available contextual metadata, to receive inbound user interactions and responses during ongoing communications, and to route such interactions back to interaction control server 340 with all available context for processing by identity management service 341, opt-in state manager 342, and personalization and inference manager 344, and for potential forwarding to downstream lead destinations 360.

The system further comprises downstream lead destinations 360, which may include a customer relationship management system 361, a call center 362, a sales agent 363, an external API 364, and a loyalty management system 365. Downstream lead destinations 360 are configured to receive redirected leads and interaction context from interaction control server 340, enabling businesses to respond to user engagement with products or services.

The loyalty management system 365 is configured to manage loyalty programs, reward points, incentive structures, and customer engagement benefits associated with user identities maintained by identity management service 341, to track user engagement activities and assign loyalty value or points based on interactions, purchases, or other qualifying behaviors, to provide loyalty status information and available rewards to interaction control server 340 for use in message personalization and user engagement strategies, to deliver loyalty benefits including discounts, exclusive offers, or reward redemptions through messaging channels coordinated by messaging gateway 350 and interaction control server 340 without requiring users to install dedicated loyalty applications, to integrate loyalty wallet functionality directly into messaging interactions by presenting loyalty information, available rewards, and redemption options within RCS messages or other message formats when capabilities permit, to receive loyalty-relevant user actions and transactions from interaction control server 340 for loyalty account updates and reward calculations, and to enable phone-number-anchored loyalty identification wherein users are recognized and rewarded based on their phone number identity without requiring separate loyalty account credentials or application installations. The loyalty management system 365 enables persistent loyalty engagement tied to phone number identity, creating switching costs and ongoing value that compounds over time alongside the identity and preference data accumulated by identity management service 341 and personalization and inference manager 344.

Downstream lead destinations 360 are further configured to receive formatted data or requests for further user contact from interaction control server 340, wherein the received data comprises user identity information from identity management service 341, interaction context, campaign identifiers, product or service information, communication preference data derived from personalization and inference manager 344, opt-in state from opt-in state manager 342, consent information, enriched behavioral insights, and loyalty status from loyalty management system 365, to receive data about the context and identity and implicit preferences of users based on their interactions, to receive such data in formats tailored to each destination's technical capabilities using preferred or preconfigured formatting or data transmission methods such as proprietary APIs or generalized JSON objects, to save and store information on how to interact with users for future communications including preferred communication protocols, contact information, interaction history, product interests, campaign context, and opt-in state information, to access and utilize accumulated user context and preference information for ongoing relationship management and follow-up interactions, and to conduct future communications with users through messaging gateway 350 and interaction control server 340 rather than establishing direct communication channels, thereby allowing the system to preserve privacy protections by masking direct contact information between users and business resources, maintain session continuity and attribution across multiple interaction points and time periods, enable ongoing updates to user context and identity over time through identity management service 341 and personalization and inference manager 344, and ensure that all communications remain subject to opt-in state and channel eligibility determinations managed by opt-in state manager 342 and channel eligibility service 343.

The interaction control server 340 may route user interactions to one or more of the downstream lead destinations 360 based on campaign configuration, user responses, routing logic executed by channel eligibility service 343 or other routing components, availability of destination resources, user identity attributes from identity management service 341, engagement predictions from personalization and inference manager 344, or loyalty status from loyalty management system 365, while preserving session continuity, attribution data, and privacy protections across the engagement lifecycle. The routing may be performed using conditional logic that considers campaign or activation asset associations, content or type of user responses, current messaging channel and capability state, session history or interaction sequence, business rules or configuration parameters, and personalized routing strategies optimized for each user identity.

In operation, the interaction control server 340 may first establish a preferred or default communication protocol based on user device type, wherein device-identifying information such as email address, phone number, or other identifiers indicates the basic device type or communication methods available to the user. The interaction control server 340, through coordination between identity management service 341 and channel eligibility service 343, then sends out digital activation asset(s) to messaging gateway 350, which determines the messaging protocol and methodology to use for the user based on user signup contact information through consultation with channel eligibility service 343 and RCS platform interface 351, assessing device capabilities, carrier support, and platform constraints to select an appropriate channel such as email, SMS, MMS, or RCS. Digital activation assets 320 are received by user device(s) 310 in a format appropriate for the receiving device and communication channel, such as a QR code received by email address, a redirect link sent via SMS message, or a call-to-action button embedded in an RCS message delivered through RCS platform interface 351. A user may interact with one of the digital activation assets 320 using a user device 310 by tapping, clicking, scanning, or otherwise using the digital activation asset, which generates an interaction signal that is sent to messaging gateway 350 over network 330.

Messaging gateway 350 receives the digital activation asset interaction and forwards the digital asset activation/interaction and context data, including communication protocol(s) used, device type, platform information, and other available metadata, to interaction control server 340. The interaction control server 340 processes the received interaction using identity management service 341 to determine user identity and communication preferences using contextual data, which may involve matching the interaction to an existing user profile based on phone number, email address, device identifier, or other identifying information, creating a new identity profile if none exists with phone number as the persistent identity anchor, and inferring communication preferences from the protocol used, stored user profile data, or prior interaction history. The opt-in state manager 342 records an opt-in event triggered by the interaction, capturing contextual metadata and establishing or updating opt-in state information that governs subsequent messaging eligibility.

Based on the opt-in state from opt-in state manager 342, device capabilities negotiated through RCS platform interface 351, carrier support information, and verification status, the channel eligibility service 343 within interaction control server 340 determines whether RCS messaging is eligible for the interaction, consulting capability profiles and applying eligibility rules. If RCS is eligible, channel eligibility service 343 instructs messaging gateway 350 to deliver an RCS message through RCS platform interface 351 with enhanced features such as branded sender identity, rich card layout, or interactive buttons. If RCS is not eligible, channel eligibility service 343 selects an alternative protocol such as SMS or MMS while preserving interaction intent. The personalization and inference manager 344 may influence message content, timing, and presentation based on accumulated intelligence about the user identity to optimize engagement likelihood.

The interaction control server 340 sends formatted data or requests for further user contact to downstream lead destinations 360, which may include user identity information from identity management service 341, interaction context, campaign identifiers, communication preference data from personalization and inference manager 344, opt-in state information from opt-in state manager 342, and loyalty status from loyalty management system 365. Downstream lead destinations 360 save information on how to interact with the user for future communications, storing preferred communication protocols, contact information, interaction history, and consent information in customer relationship management system 361 or other data repositories.

User responses or interactions with delivered messages are received by messaging gateway 350, which sends data to interaction control server 340 comprising the interaction and all context available to the message, including protocol, device type, platform, carrier network, timestamp, and other contextual metadata. The identity management service 341 associates the response with the user's identity profile and updates accumulated contextual data. The personalization and inference manager 344 processes the new interaction data to refine behavioral models and preference predictions. The interaction control server 340 sends data about the context and identity and implicit preferences of the user based on the interaction to downstream lead destinations 360 using preferred or preconfigured formatting or data transmission methods such as proprietary APIs or generalized JSON objects.

User contact via downstream lead destinations 360 continues to go through messaging gateway 350 and interaction control server 340, allowing for updates to user context and identity over time through continuous operation of identity management service 341 and personalization and inference manager 344. Future communications with users are done over preferred communication medium and protocol determined by channel eligibility service 343 based on accumulated preference data from personalization and inference manager 344, to preferred device identified through device association tracking in identity management service 341, using all available context without asking the user to directly confirm information, thereby enabling frictionless continuation of interactions across sessions and time periods while respecting established identity managed by identity management service 341, preferences inferred by personalization and inference manager 344, and opt-in state maintained by opt-in state manager 342. Such user responses or interactions with delivered messages may trigger lead redirection actions, causing interaction control server 340 to route the engagement to one or more downstream lead destinations 360, potentially including loyalty management system 365 for loyalty program updates, while maintaining interaction context and attribution information throughout the engagement lifecycle through coordinated operation of all sub-components within interaction control server 340.

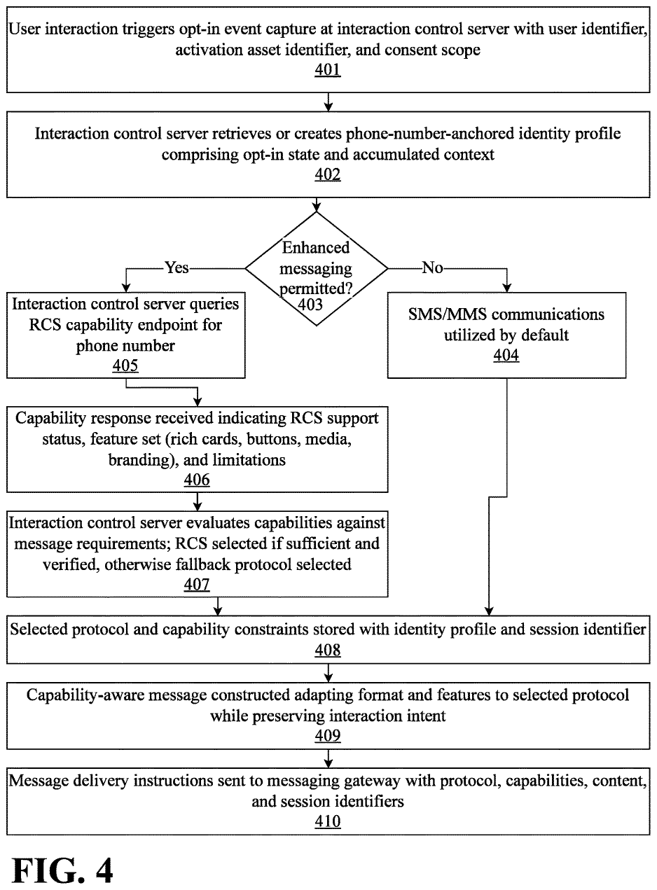

FIG. 4 is a method diagram illustrating steps for opt-in-gated RCS channel eligibility determination and capability negotiation, according to an embodiment. This method demonstrates how the system conditionally enables Rich Communication Services messaging based on opt-in state evaluation and dynamic capability assessment, while providing robust fallback to alternative messaging protocols when RCS is unavailable or ineligible.

A user interaction triggers opt-in event capture at the interaction control server with user identifier, activation asset identifier, and consent scope 401. The user interaction may result from activation of a digital activation asset such as a call-to-action button, redirect link, or QR code as described in other figures herein. The captured opt-in event comprises identifying information such as a phone number serving as the user identifier, an identifier associated with the specific activation asset that triggered the interaction, campaign or product context, and consent scope parameters indicating the type and extent of messaging permissions being granted. This opt-in event serves as a structured system input that governs subsequent messaging behavior and channel eligibility determinations, rather than merely serving as a binary permission flag.

The interaction control server retrieves or creates a phone-number-anchored identity profile comprising opt-in state and accumulated context 402. The interaction control server, utilizing identity management service 341 as illustrated in FIG. 3, queries an identity database using the phone number from the previous step as the primary key. If an existing identity profile is found, the system retrieves accumulated data including prior opt-in records, interaction history, device associations, communication preferences, and contextual observations collected over time. If no existing profile is found, the system creates a new identity record with the phone number serving as the persistent identifier or “identity DNA” that will anchor all future interactions and data accumulation for this user. The identity profile serves as a persistent repository for compounding intelligence about the user's preferences, behaviors, and engagement patterns.

The system evaluates whether enhanced messaging is permitted 403. The opt-in state manager 342 within the interaction control server evaluates the opt-in state information retrieved or established in the preceding step, considering the consent scope parameters captured during opt-in event capture and any applicable time limitations, purpose restrictions, or channel-specific permissions. The system determines whether the opt-in grants permission only for basic messaging (SMS/MMS) or extends to enhanced messaging capabilities including RCS. This evaluation represents a conditional decision point in the method flow that determines whether the system proceeds to evaluate RCS-specific eligibility criteria or immediately selects fallback protocols.

If enhanced messaging is not permitted, SMS/MMS communications are utilized by default 404. When the opt-in state evaluation at step 403 determines that enhanced messaging capabilities are not authorized by the user's consent, the method bypasses RCS capability evaluation entirely and proceeds directly to select SMS or MMS as the messaging protocol. This default fallback path ensures that messaging channel selection respects user consent boundaries and compliance requirements from the outset, preventing any attempt to use enhanced features when authorization has not been granted. The system then proceeds to message construction and delivery using the selected fallback protocol while maintaining interaction continuity and session tracking.

If enhanced messaging is permitted, the interaction control server queries an RCS capability endpoint for the phone number 405. When the opt-in state evaluation at step 403 determines that enhanced messaging is authorized, the channel eligibility service 343 within the interaction control server, working in coordination with RCS platform interface 351 of the messaging gateway as illustrated in FIG. 3, initiates a capability negotiation process. The system transmits a capability query to an external RCS platform service, carrier network capability endpoint, or RCS business messaging provider, providing the user's phone number as the identifier for which capability information is requested. This query seeks to determine whether the user's device and carrier support RCS messaging and, if so, which specific RCS features and capabilities are available. The capability negotiation may occur in real-time or may retrieve previously cached capability information if such information is available and sufficiently recent.

A capability response is received indicating RCS support status, feature set comprising rich cards, buttons, media, branding, and limitations 406. The RCS platform interface 351 receives the capability response from the queried endpoint, which contains structured data describing the RCS capabilities available for the specified phone number. The capability response indicates whether RCS is supported at all for this user, and if supported, provides a detailed feature set description. The feature set may indicate support for rich card layouts that enable structured message presentation, interactive buttons and suggested replies that enable user actions without typing, rich media capabilities including images, videos, or documents, branded sender identity elements including business name and logo display, persistent conversation sessions, and any limitations such as message size restrictions, supported media types, or interaction frequency constraints. The capability response may also include information about platform or carrier participation, device compatibility, and verification requirements.

The interaction control server evaluates capabilities against message requirements; RCS is selected if sufficient and verified, otherwise fallback protocol is selected 407. The channel eligibility service 343 compares the capability profile received in the previous step against the requirements of the intended message interaction, considering factors such as whether the message design requires interactive buttons, rich media, or branded presentation, whether the available RCS capabilities are sufficient to deliver the intended user experience, whether business verification status has been established to enable branded messaging, and whether any capability limitations would prevent essential message features from functioning. Based on this evaluation, the system makes a protocol selection decision. If RCS capabilities are sufficient for the intended interaction and verification status is confirmed, RCS is selected as the messaging protocol and the method proceeds to message construction. If RCS capabilities are insufficient, unavailable, or verification status is incomplete, the system selects an alternative protocol such as SMS or MMS, ensuring that the interaction can proceed despite the unavailability of enhanced features.

The selected protocol and capability constraints are stored with the identity profile and session identifier 408. The interaction control server records the protocol selection decision and associated capability information in multiple locations for future reference. The selected protocol is associated with the user's identity profile maintained by identity management service 341, enabling the system to reference prior successful protocols when planning future interactions with this user. The capability constraints, which define which features are available or restricted for this interaction, are stored with the session identifier to ensure consistent behavior throughout the current interaction session. Additionally, if RCS capabilities were successfully negotiated, the capability profile may be cached for reuse in future interactions, reducing the need for repeated capability queries. This storage enables the system to learn from each interaction and to apply accumulated knowledge in subsequent engagements.

A capability-aware message is constructed adapting format and features to the selected protocol while preserving interaction intent 409. The interaction control server prepares the message content using the protocol selected in the prior evaluation step and applying the capability constraints just stored. If RCS was selected, the message is formatted to leverage available RCS features such as rich card layouts, interactive buttons, branded sender identity, and rich media, creating an engaging and visually rich user experience. If SMS or MMS was selected due to RCS unavailability or opt-in limitations, the same interaction intent is expressed using the constraints of the fallback protocol, which may involve converting rich layouts to plain text descriptions, replacing interactive buttons with text-based instructions or numbered reply options, presenting branding information as text identifiers rather than visual elements, and simplifying or omitting media that cannot be delivered via the selected protocol. Throughout this adaptation process, the core interaction logic, call-to-action intent, and essential information content are preserved, ensuring that users receive functionally equivalent experiences regardless of which protocol is ultimately used. This capability-aware construction allows the same underlying interaction design to be expressed appropriately across different messaging channels.

Message delivery instructions are sent to the messaging gateway with protocol, capabilities, content, and session identifiers 410. The interaction control server transmits a comprehensive message delivery request to messaging gateway 350, providing all information necessary for the gateway to deliver the message successfully. The delivery instructions specify the selected messaging protocol (RCS, SMS, or MMS) determined through the eligibility and capability evaluation process, the capability constraints or feature profile that should be applied if using RCS, the fully formatted message content prepared in the previous step and ready for transmission, session identifiers that enable tracking and attribution of the message within the ongoing interaction session, user identity information including the phone number to which the message should be delivered, and any additional metadata relevant to delivery tracking or analytics. The messaging gateway receives these instructions and proceeds to deliver the message to the user device using the specified protocol and format, completing the opt-in-gated, capability-aware message delivery process. Subsequent user responses or interactions with the delivered message may be processed according to methods described in other figures, with the session identifier enabling continuity across multiple message exchanges.

This method demonstrates how the disclosed system integrates opt-in state management, conditional eligibility evaluation, RCS capability negotiation, protocol selection, and capability-aware message construction into a unified flow that ensures compliant, optimized messaging experiences while maintaining robust fallback capabilities when enhanced features are unavailable. The conditional logic structure at step 403 ensures that RCS capability negotiation occurs only when authorized by opt-in state, while the default SMS/MMS path 404 provides immediate fallback when enhanced messaging is not permitted, creating an efficient and compliance-focused channel selection mechanism.

FIG. 5 is a method diagram illustrating steps for maintaining session continuity and seamless fallback during RCS to SMS channel transition, according to an embodiment. This method demonstrates how the system preserves interaction context, conversation history, and user intent when transitioning between messaging protocols due to capability changes or delivery failures, ensuring uninterrupted user experience despite underlying technical constraints.

An active RCS session is established with session ID, user identity, interaction history, and capability profile 501. The interaction control server 340 and messaging gateway 350, as illustrated in FIG. 3, initiate and maintain an ongoing messaging session using Rich Communication Services protocol. The session comprises a session identifier that uniquely identifies this conversation thread and enables tracking across multiple message exchanges, user identity information anchored to the phone number as maintained by identity management service 341, interaction history recording all prior messages and user responses within this session, and a capability profile documenting the RCS features available for this interaction as determined through the capability negotiation processes described in other figures. The RCS session enables enhanced messaging features including rich card layouts, interactive buttons, branded sender identity, and persistent conversation threading. The session state is maintained by the interaction control server to support multi-step interactions, attribution tracking, and context preservation across message exchanges.

A user interaction is received via RCS, forwarded to interaction control server with session ID 502. The user engages with the RCS message delivered in the active session, which may involve sending a reply message, selecting an interactive button, choosing a suggested reply, or taking other actions enabled by RCS features. The messaging gateway 350 receives the user's interaction through RCS platform interface 351 and forwards the interaction data to interaction control server 340. The forwarded data includes the session identifier established in the previous step, enabling the system to associate this user action with the ongoing conversation thread, the content of the user's response or the specific action taken, contextual metadata such as timestamp and interaction type, and any other information captured through the RCS channel. The session identifier serves as the key mechanism for maintaining conversation continuity, allowing the interaction control server to retrieve the full context of prior exchanges and to process the current interaction as part of an ongoing engagement rather than as an isolated event.

The next RCS message is prepared with enhanced features comprising rich card, buttons, and branding 503. The interaction control server 340, utilizing the session context and conversation history retrieved via the session identifier, determines the appropriate next step in the interaction flow and prepares a response message. The message is formatted for RCS delivery with enhanced presentation features including a rich card layout that structures information in an engaging visual format, interactive buttons or suggested replies that enable user actions without requiring typed responses, branded sender identity elements displaying business name and logo as enabled by verification status, rich media content such as images or videos if appropriate to the interaction, and any other RCS capabilities identified in the session's capability profile. The message is designed to continue the conversation thread established in the session and to advance toward the interaction goal, which may be lead qualification, information provision, transaction completion, or handoff to a downstream destination.

RCS delivery is attempted via messaging gateway 504. The interaction control server 340 transmits the prepared RCS message to messaging gateway 350 with instructions to deliver the message to the user's phone number using the RCS protocol. The messaging gateway, working through RCS platform interface 351, initiates the delivery process by connecting to carrier RCS networks or RCS business messaging platforms, transmitting the formatted message with all enhanced features, and monitoring for delivery confirmation. The delivery attempt proceeds under the assumption that RCS capabilities that were available when the session was established remain available for continued use.

A delivery failure is encountered due to device no longer being RCS-capable, service unavailable, or network issues 505. The RCS delivery attempt fails to complete successfully for any of several possible reasons. The user's device may no longer support RCS due to software changes, network switching, or device configuration changes that have occurred since the session was established. The RCS service may be temporarily unavailable due to carrier network issues, platform maintenance, or service disruptions affecting the RCS infrastructure. Network conditions such as connectivity problems, signal loss, or data service interruptions may prevent RCS message delivery. The device may have transitioned to a network or carrier that does not support RCS messaging. Any of these conditions results in a delivery failure event detected by the messaging gateway 350 through lack of delivery confirmation, explicit error messages from RCS platform services, or timeout conditions indicating the message could not be delivered within expected timeframes.

A failure notification is sent to interaction control server with session ID and available alternatives 506. The messaging gateway 350 generates and transmits a delivery failure notification to interaction control server 340 upon detecting the RCS delivery failure. The notification includes the session identifier that associates the failed delivery with the ongoing conversation, diagnostic information describing the nature of the delivery failure such as capability unavailability or network error, identification of available alternative messaging protocols that may be used for fallback such as SMS or MMS, and any relevant technical details that may inform the fallback decision. This notification triggers the channel transition logic that will enable the interaction to continue despite the RCS delivery failure.

Session state and conversation context are retrieved using session ID, preserving history and intent 507. The interaction control server 340, upon receiving the delivery failure notification, uses the session identifier to retrieve the complete session state from its data stores. The retrieved context includes the full interaction history showing all prior messages exchanged within this session, the current position within the interaction flow indicating what information has been provided and what steps remain, the user identity and associated profile data from identity management service 341, the original interaction intent such as lead qualification, information request, or transaction pursuit, campaign and attribution metadata linking the session to specific marketing initiatives, and any other contextual information relevant to continuing the conversation. This retrieval ensures that the session can continue seamlessly despite the channel transition, with no loss of context or requirement for the user to restart the interaction or re-provide information.

The message is auto-regenerated for SMS/MMS: rich layout adapted to text, buttons converted to numbered options, branding preserved as text 508. The interaction control server 340, utilizing the retrieved session context and the original message intent, automatically reformats the RCS message that failed to deliver into a version compatible with SMS or MMS protocols. The adaptation process involves converting rich card layouts into plain text descriptions that convey the same information in a linear format suitable for SMS display, replacing interactive buttons with text-based instructions that present the available user actions as numbered options such as “Reply 1 for Option A, 2 for Option B,” preserving branded sender identification by including business name and identification information as text within the message body or sender name field as protocol capabilities permit, simplifying or omitting rich media content that cannot be delivered via SMS, or converting to MMS if images or limited media can be included, and restructuring the message flow to maintain the same interaction logic and call-to-action intent while adapting to the constraints of the fallback protocol. Throughout this adaptation, the core purpose of the message and the intended next step in the interaction flow are preserved, ensuring functional equivalence even though the presentation is simplified. The regeneration happens automatically without requiring manual intervention or interruption of the interaction flow.

The session record is updated reflecting channel transition while maintaining session ID continuity 509. The interaction control server 340 modifies the session metadata to document the protocol transition event, recording that the session has transitioned from RCS to SMS/MMS due to delivery failure, updating the capability profile associated with the session to reflect the constraints and features available via the fallback protocol, maintaining the same session identifier to ensure continuity of tracking and attribution across the protocol change, and logging the transition event with timestamp and reason for analytics and operational monitoring purposes. The continued use of the same session identifier is critical to maintaining conversation threading and context despite the underlying protocol change, enabling the system to treat the interaction as a continuous conversation rather than as separate disconnected exchanges.

The adapted message is sent via alternative protocol with session ID maintained 510. The interaction control server 340 transmits the reformatted message to messaging gateway 350 with instructions to deliver via SMS or MMS. The messaging gateway delivers the message using standard SMS or MMS protocols, which have broader compatibility and reliability than RCS but lack the enhanced features. The message includes or is associated with the session identifier through encoding in message content, metadata, or system linkage that enables subsequent responses to be matched to the session. The user receives the message via SMS/MMS on their device, experiencing a seamless continuation of the conversation despite the protocol transition that occurred transparently in the background.

A user response is received via SMS, forwarded with session ID to interaction control server 511. The user replies to the adapted message using standard SMS reply functionality, which may involve typing a free-form response or sending one of the numbered options presented in the adapted message format. The messaging gateway 350 receives the SMS response and forwards it to interaction control server 340 along with the session identifier that associates this response with the ongoing conversation. The interaction control server can process the response in the context of the full session history despite the response arriving via a different protocol than the protocol used when the session began.

The response is matched to existing session despite channel change, preserving full context 512. The interaction control server 340 uses the session identifier to retrieve the session state and match the user's SMS response to the appropriate point in the conversation flow. The system interprets the response in the context of the prior messages and the current interaction state, processes numbered option selections or free-form text responses appropriately based on what was requested in the adapted message, and continues the interaction logic as designed without disruption due to the protocol transition. The full conversation context including messages exchanged via RCS before the transition and messages exchanged via SMS after the transition is maintained as a unified session, enabling proper attribution, analytics, and interaction flow management. The user experiences seamless continuity without awareness of the underlying protocol change.

The session continues via alternative protocol; may transition back to RCS if capability restored 513. Subsequent messages in the conversation are delivered via SMS/MMS as the interaction progresses toward completion or handoff to downstream destinations. The channel eligibility service 343 within interaction control server 340 may periodically reevaluate RCS capability for this user's phone number, and if RCS capability is restored due to network changes, service restoration, or device configuration updates, the system may transition the session back to RCS protocol for subsequent messages to re-enable enhanced features. Any such transition back to RCS would follow the same seamless process described in prior steps, maintaining session identifier continuity and preserving conversation context. The ability to transition bidirectionally between protocols based on real-time capability assessment ensures optimal user experience when enhanced features are available while maintaining robust fallback and recovery capabilities.

Session termination or handoff occurs with complete history preserved across channel transitions 514. When the interaction reaches its conclusion, whether through completion of the intended action, user disengagement, timeout, or handoff to downstream lead destinations 360 such as customer relationship management system 361, sales agent 363, or call center 362, the complete session history is preserved. The preserved history includes all messages exchanged regardless of protocol used, documentation of channel transitions and the reasons for them, user responses and interactions across both RCS and SMS/MMS segments of the conversation, attribution and campaign tracking data, and outcome or disposition information. This complete preservation enables comprehensive analytics showing the full user journey despite protocol variations, supports downstream systems with full context for follow-up interactions, maintains compliance and audit trails documenting the complete interaction sequence, and informs future optimization of channel selection and fallback strategies. The seamless handling of protocol transitions demonstrated in this method ensures that users experience uninterrupted engagement and that businesses maintain complete visibility and control over customer interactions regardless of underlying technical constraints or capability variations.

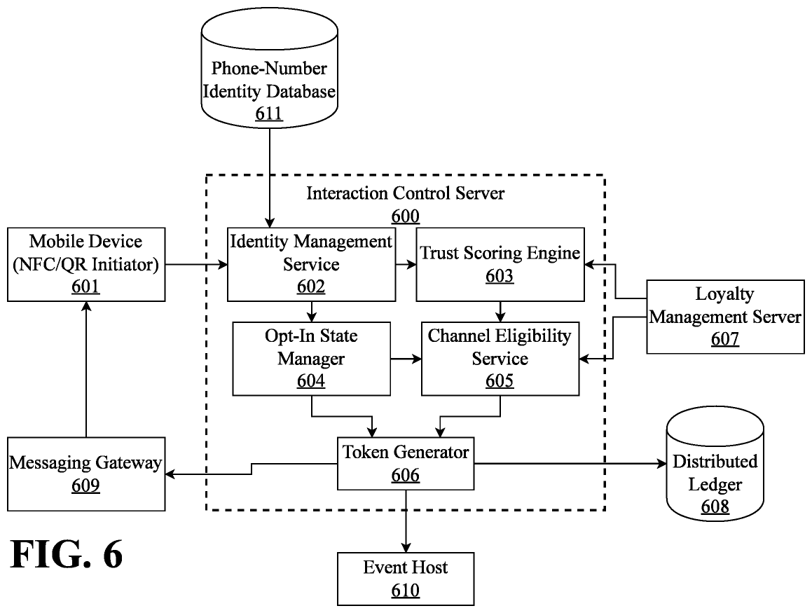

FIG. 6 is a block diagram illustrating an exemplary system architecture for an identity-weighted token generation system 600, according to an embodiment. The system 600 extends a dynamic-link verification platform by introducing persistent phone-number-anchored identity as a determinative input to access token generation, such that the parameters of a generated token reflect the accumulated verification history and trust context of the user rather than treating each verification event as an isolated transaction.

According to the embodiment, a mobile device 601, such as a smartphone or other NFC-capable computing device, serves as the point of user interaction with the system 600. The mobile device 601 interacts with a near-field communication beacon or quick-response code initiator, the interaction causing an auto-populated text message comprising a payload and initiator identifier to be transmitted to the system 600. The mobile device 601 additionally receives the generated access token from the system 600 upon successful identity-weighted verification, as further described herein.

The system 600 comprises an interaction control server 600 within which several constituent services operate in coordination. The interaction control server 600 is depicted with a dashed boundary indicating the logical grouping of its internal services. The interaction control server 600 is communicatively coupled to the mobile device 601, a messaging gateway 609, a phone-number identity database 611, a loyalty management server 607, a distributed ledger 608, and an event host 610, each of which is described in further detail below.

An identity management service 602 operates within the interaction control server 600 and is configured to maintain persistent user identity profiles anchored to phone numbers as primary identifiers. Upon receipt of an interaction from the mobile device 601, the identity management service 602 queries the phone-number identity database 611 using the phone number associated with the interaction as the primary key, retrieving accumulated contextual data comprising prior interaction history, device associations, communication preferences, opt-in records, and engagement patterns if an existing profile is found, or initializing a new identity record if no prior profile exists. The identity management service 602 provides the retrieved or initialized identity data to the trust scoring engine 603 and the opt-in state manager 604 for further processing.

The phone-number identity database 611 is communicatively coupled to the identity management service 602 and serves as the persistent data store for phone-number-anchored identity profiles. The phone-number identity database 611 stores accumulated contextual intelligence associated with each identity, including confidence indicators, behavioral observations, device associations, and historical opt-in state transitions, and is updated by the identity management service 602 upon each interaction to reflect newly acquired contextual data.

A trust scoring engine 603 operates within the interaction control server 600 and is configured to receive accumulated identity data from the identity management service 602 and loyalty status information from the loyalty management server 607, and to compute an identity confidence score reflecting the depth and quality of the user's verified identity history. The trust scoring engine 603 applies inference logic and behavioral analysis to the accumulated data to derive a confidence score that is used to weight the parameters of the access token to be generated. A user with no prior interaction history will receive a lower confidence score resulting in a more restrictive token configuration, while a user with a rich and consistent verification history will receive a higher confidence score enabling a more privileged token configuration. The trust scoring engine 603 provides the computed confidence score to the token generator 606 as a determinative input to token parameter selection.

An opt-in state manager 604 operates within the interaction control server 600 and is configured to evaluate and maintain the opt-in state associated with the interacting user. The opt-in state manager 604 receives identity data from the identity management service 602 and determines the current opt-in state governing messaging eligibility and access privilege level. The opt-in state manager 604 provides opt-in state information to both the channel eligibility service 605 and the token generator 606, such that the generated token reflects the user's consent scope in addition to their identity confidence level.

A channel eligibility service 605 operates within the interaction control server 600 and is configured to determine the appropriate messaging protocol for token delivery based on opt-in state information received from the opt-in state manager 604 and capability information negotiated with external platform services. The channel eligibility service 605 provides protocol selection parameters to the token generator 606 such that the token may be formatted and delivered appropriately for the selected channel.

The token generator 606 operates within the interaction control server 600 and is configured to receive the identity confidence score from the trust scoring engine 603, opt-in state parameters from the opt-in state manager 604, and channel selection parameters from the channel eligibility service 605, and to generate an identity-weighted access token whose entropy, privilege level, and format reflect the combined inputs of these services. The parameters of the generated token are not fixed by an access rule alone but are dynamically adjusted based on the identity confidence score such that the token encodes a trust-differentiated entitlement. Upon generating the token, the token generator 606 transmits the token to the messaging gateway 609 for delivery to the mobile device 601, writes an enriched entry to the distributed ledger 608, and sends a tiered status notification to the event host 610.

The loyalty management server 607 is communicatively coupled to the trust scoring engine 603 and is configured to provide loyalty status information associated with the user's phone-number-anchored identity, including loyalty tier, reward status, and engagement value indicators. The loyalty management server 607 enables the trust scoring engine 603 to incorporate loyalty context into the confidence score computation, and may additionally influence the privilege parameters applied by the token generator 606 to reflect loyalty-based access entitlements such as expedited entry or tier-based physical access zones.

The messaging gateway 609 is communicatively coupled to the token generator 606 and the mobile device 601 and is configured to receive the generated access token from the token generator 606 and deliver it to the mobile device 601 using the messaging protocol selected by the channel eligibility service 605. The messaging gateway 609 supports multiple messaging protocols including Rich Communication Services (RCS), Short Message Service (SMS), and Multimedia Messaging Service (MMS), and selects among these based on device capability and opt-in state as determined by the channel eligibility service 605.

The distributed ledger 608 is communicatively coupled to the token generator 606 and is configured to receive and store an enriched ledger entry upon each token issuance. The ledger entry recorded by the system 600 comprises not only the generated token but additionally the identity confidence score at the time of issuance, the messaging protocol used for delivery, the opt-in state at the time of issuance, and the loyalty tier of the user, creating an auditable trust evolution record that may be referenced by the event host 610 and the identity management service 602 in subsequent interactions to inform adaptive access policy decisions.

The event host 610 is communicatively coupled to the token generator 606 and is configured to receive a tiered status notification upon token generation, wherein the notification reflects the access privilege level encoded in the generated token rather than a binary verification confirmation. The event host 610 provides access to a controlled physical location in accordance with the privilege level indicated by the notification and upon activation of the access token by the mobile device 601.

FIG. 7 is a block diagram illustrating an exemplary system architecture for a consent-gated access level system, according to an embodiment. The system 700 introduces a multi-state opt-in model as the governing structure for physical access entitlement determination, wherein the level of access privilege assigned to a user is a function of their accumulated consent state rather than a binary permitted or denied determination. The system 700 comprises an interaction control server 700, depicted with a dashed boundary indicating the logical grouping of its internal services, which is communicatively coupled to a mobile device 710, a messaging gateway 712, a loyalty management server 707, and an event host 711.

According to the embodiment, a mobile device 710, such as a smartphone or other NFC-capable computing device, serves as the point of user interaction with the system 700. The mobile device 710 interacts with a near-field communication beacon or quick-response code initiator, the interaction causing an opt-in event to be captured by the interaction control server 700 comprising the user's phone number, activation asset identifier, and consent scope parameters. The mobile device 710 additionally receives the generated access token from the messaging gateway 712 upon successful entitlement determination, as further described herein.

The interaction control server 700 comprises an opt-in state manager 706, an opt-in state model 701, an access entitlement resolver 708, and a token generator 709, each of which operates in coordination to evaluate the user's consent state and produce a correspondingly privileged access token.

The opt-in state manager 706 operates within the interaction control server 700 and is configured to capture opt-in events triggered by user interactions with digital activation assets, to maintain opt-in state information using a state-based model rather than binary permission flags, and to evaluate the current opt-in state of a user upon each interaction. The opt-in state manager 706 enforces state transitions in response to user actions, elapsed time, campaign context changes, or external verification processes, and provides the current opt-in state to the access entitlement resolver 708 as a primary input to access privilege determination.

The opt-in state model 701 is depicted within the interaction control server 700 as an inner dashed grouping comprising four discrete states that define the range of messaging eligibility and access entitlement levels available within the system 700. State 0 702 represents the absence of any opt-in, wherein no messaging is permitted and no access token is generated. Users in State 0 702 are routed directly to the messaging gateway 712 with a denial or deferral response without proceeding to the access entitlement resolver 708 or token generator 709. State 1 703 represents a basic opt-in level, wherein standard messaging is permitted and a standard access token with basic entitlement parameters is eligible for generation. State 2 704 represents an enhanced messaging opt-in level, wherein Rich Communication Services delivery is permitted and an enhanced access token reflecting elevated entitlement is eligible for generation. State 3 705 represents a verified identity and loyalty-confirmed opt-in level, wherein the highest tier of access entitlement is available, including expedited entry, tier-based physical access zones, and loyalty-augmented access privileges as further described with respect to the loyalty management server 707.

The loyalty management server 707 is communicatively coupled to the access entitlement resolver 708 and is configured to provide loyalty status information associated with the user's phone-number-anchored identity, including loyalty tier, reward status, and engagement value indicators. The loyalty management server 707 operates as a secondary input to the access entitlement resolver 708, supplementing the opt-in state with loyalty context such that users in State 3 705 may receive dynamically adjusted access privileges reflecting their loyalty standing in addition to their verified identity status.

The access entitlement resolver 708 operates within the interaction control server 700 and is configured to receive the current opt-in state from the opt-in state manager 706 and loyalty status information from the loyalty management server 707, and to produce a unified access entitlement parameter set that is transmitted to the token generator 709. The access entitlement resolver 708 applies prioritization logic that maps each opt-in state to a corresponding access privilege tier, with the loyalty management server 707 operating as a modifier on top of the opt-in state evaluation for users in State 3 705. Users in State 0 702 do not reach the access entitlement resolver 708, as the opt-in state manager 706 routes such interactions directly to a denial or deferral response prior to entitlement resolution.

The token generator 709 operates within the interaction control server 700 and is configured to receive the access entitlement parameter set from the access entitlement resolver 708 and to generate an access token whose privilege level, entropy, and format reflect the assigned entitlement tier. The token generator 709 transmits the generated token to the messaging gateway 712 for delivery to the mobile device 710 and sends a tiered status notification to the event host 711 indicating the privilege level of the issued token.

The messaging gateway 712 is communicatively coupled to the token generator 709 and the mobile device 710 and is configured to receive the generated access token from the token generator 709 and deliver it to the mobile device 710 using a messaging protocol appropriate to the user's opt-in state and device capabilities. For users in State 2 704 or State 3 705, the messaging gateway 712 may deliver the token via Rich Communication Services where device capability and carrier support permit, while users in State 1 703 receive token delivery via Short Message Service or Multimedia Messaging Service. Users in State 0 702 receive no token delivery, as the interaction is terminated prior to token generation.

The event host 711 is communicatively coupled to the token generator 709 and is configured to receive a tiered status notification upon token generation, wherein the notification reflects the access privilege level encoded in the generated token. The event host 711 provides access to a controlled physical location in accordance with the privilege level indicated by the notification and upon activation of the access token by the mobile device 710, such that different users may be granted access to different physical zones, entry lanes, or privilege tiers based on their consent state and loyalty standing as determined by the system 700.

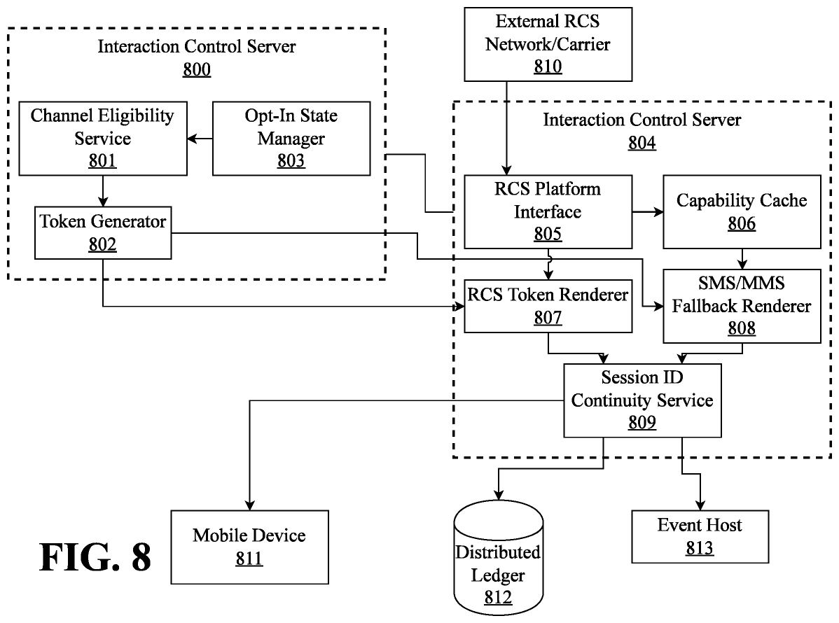

FIG. 8 is a block diagram illustrating an exemplary system architecture for an RCS capability-aware token delivery system, according to an embodiment. The system introduces a protocol-intelligent delivery layer to access token transmission, wherein the format, presentation, and channel used to deliver a generated access token are dynamically determined based on the user's opt-in state, device capabilities, and carrier support, while a session identifier threads through all delivery paths to preserve interaction continuity regardless of which protocol is ultimately used.

The system comprises an interaction control server 800 and a messaging gateway 804, each depicted with a dashed boundary indicating the logical grouping of their respective internal services. The interaction control server 800 is communicatively coupled to the messaging gateway 804, and the messaging gateway 804 is communicatively coupled to an external RCS network and carrier 810, a mobile device 811, a distributed ledger 812, and an event host 813.

The interaction control server 800 comprises an opt-in state manager 803, a channel eligibility service 801, and a token generator 802, each of which operates in coordination to determine the appropriate delivery protocol and prepare the token for transmission.

The opt-in state manager 803 operates within the interaction control server 800 and is configured to maintain and evaluate the opt-in state associated with the interacting user, providing opt-in state information to the channel eligibility service 801 as a gating input to protocol eligibility determination. The opt-in state manager 803 ensures that enhanced messaging capabilities including Rich Communication Services are only considered for delivery when the user's consent state permits such channels, and that users whose opt-in state restricts messaging to basic protocols are routed to Short Message Service or Multimedia Messaging Service delivery without proceeding to RCS capability evaluation.

The channel eligibility service 801 operates within the interaction control server 800 and is configured to receive opt-in state information from the opt-in state manager 803 and to determine messaging protocol eligibility for the current interaction. Where opt-in state permits enhanced messaging, the channel eligibility service 801 coordinates with the RCS platform interface 805 of the messaging gateway 804 to initiate capability negotiation for the user's phone number. The channel eligibility service 801 provides the resulting protocol selection and capability constraints to the token generator 802 such that the token may be appropriately formatted prior to transmission to the messaging gateway 804.

The token generator 802 operates within the interaction control server 800 and is configured to receive protocol selection parameters and capability constraints from the channel eligibility service 801 and to prepare the access token for delivery in a format appropriate to the selected protocol. The token generator 802 transmits the formatted token and associated delivery instructions, including protocol, capability constraints, and session identifier, to the messaging gateway 804 for transmission to the mobile device 811.

The messaging gateway 804 comprises an RCS platform interface 805, a capability cache 806, an RCS token renderer 807, an SMS/MMS fallback renderer 808, and a session ID continuity service 809, each of which is described in further detail below.

The RCS platform interface 805 operates within the messaging gateway 804 and is configured to communicate with the external RCS network and carrier 810 to negotiate RCS capabilities for the user's phone number by querying capability endpoints or retrieving capability information from platform services. The RCS platform interface 805 retrieves a capability profile indicating supported RCS features including rich card layouts, interactive buttons, suggested replies, rich media, and branded sender identity elements, as well as any limitations or restrictions applicable to the user's device or carrier configuration. The RCS platform interface 805 provides the retrieved capability profile to the channel eligibility service 801 within the interaction control server 800 for use in protocol selection, and additionally stores the capability profile in the capability cache 806 for reuse in subsequent interactions.

The capability cache 806 operates within the messaging gateway 804 and is configured to store previously retrieved RCS capability profiles associated with specific phone numbers or devices, reducing the need for repeated capability queries to the external RCS network and carrier 810 for users whose capability profile has already been established. The capability cache 806 is consulted by the RCS platform interface 805 prior to initiating a live capability query, and is updated upon receipt of new capability information from the external RCS network and carrier 810.

The external RCS network and carrier 810 is communicatively coupled to the RCS platform interface 805 and represents the external carrier network infrastructure and RCS platform services through which capability profiles are negotiated and RCS messages are transmitted. The external RCS network and carrier 810 provides capability responses to the RCS platform interface 805 and receives outbound RCS messages for delivery to the mobile device 811.

The RCS token renderer 807 operates within the messaging gateway 804 and is configured to receive a generated access token from the token generator 802 and format it for delivery via Rich Communication Services where the capability profile and opt-in state permit. The RCS token renderer 807 produces a capability-aware message presentation comprising a rich card layout, a branded sender identity, an interactive activation button, and read receipt functionality, such that the access token is delivered to the mobile device 811 in an enhanced and verifiable format. The RCS token renderer 807 provides the formatted message to the session ID continuity service 809 for transmission.

The SMS/MMS fallback renderer 808 operates within the messaging gateway 804 and is configured to receive a generated access token from the token generator 802 and reformat it for delivery via Short Message Service or Multimedia Messaging Service where RCS capabilities are unavailable, insufficient, or not permitted by the user's opt-in state. The SMS/MMS fallback renderer 808 adapts the token presentation by converting rich card layouts to plain text descriptions, replacing interactive buttons with numbered reply options, and preserving branded sender identification as text within the message body, such that the interaction intent and activation mechanics of the token are preserved despite the constraints of the fallback protocol. The SMS/MMS fallback renderer 808 provides the reformatted message to the session ID continuity service 809 for transmission.

The session ID continuity service 809 operates within the messaging gateway 804 and is configured to associate a session identifier with the outbound token delivery regardless of which renderer has prepared the message, ensuring that the session identifier threads through both the RCS delivery path via the RCS token renderer 807 and the fallback delivery path via the SMS/MMS fallback renderer 808. The session ID continuity service 809 transmits the prepared message and session identifier to the mobile device 811, records delivery metadata to the distributed ledger 812, and forwards a delivery confirmation to the event host 813.

The distributed ledger 812 is communicatively coupled to the session ID continuity service 809 and is configured to record delivery metadata upon each token transmission, comprising the protocol used for delivery, the session identifier, and delivery confirmation status, creating an auditable record of token delivery events that may be referenced in subsequent interactions.

The mobile device 811 is communicatively coupled to the messaging gateway 804 and is configured to receive the access token delivered by either the RCS token renderer 807 or the SMS/MMS fallback renderer 808 via the session ID continuity service 809, and to activate the token to obtain access to a controlled physical location as governed by the event host 813.

The event host 813 is communicatively coupled to the session ID continuity service 809 and is configured to receive a delivery confirmation upon token transmission and to provide access to a controlled physical location upon activation of the access token by the mobile device 811, consistent with access control operations described in various embodiments herein.

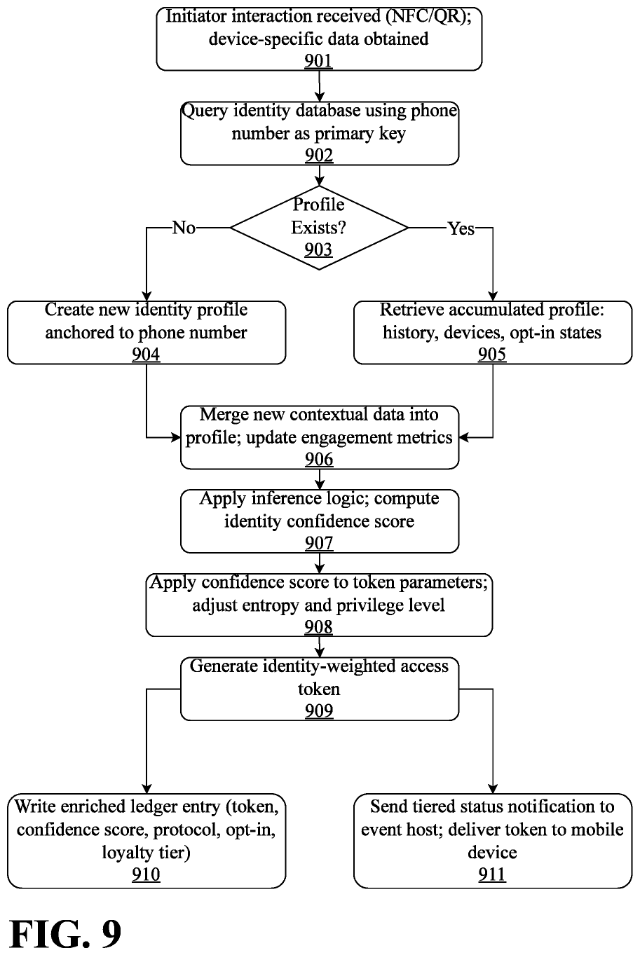

FIG. 9 is a method diagram illustrating steps for identity-weighted token generation using phone-number-anchored persistent identity as a determinative input to access token parameter selection, according to an embodiment. The method demonstrates how the system transforms accumulated verification history and contextual intelligence associated with a user's phone number identity into dynamic adjustments to the entropy, privilege level, and format of a generated access token, such that users with rich interaction histories receive tokens with elevated privilege parameters while users with minimal or absent prior engagement receive tokens with more restrictive configurations.

At step 901, an initiator interaction is received from a near-field communication beacon or quick-response code initiator, and device-specific data is obtained. The interaction comprises an auto-populated text message transmitted from a mobile device, the message containing a payload and initiator identifier that associate the interaction with a specific verification event or controlled physical location. The device-specific data obtained at this step may comprise the phone number associated with the mobile device, carrier billing information, hardware identifiers, platform information, messaging protocol capabilities, geographic or network location data derived from GPS triangulation or cell tower triangulation, and timestamp information. This device-specific data serves as the input to the identity resolution process that follows, with the phone number functioning as the primary identifier anchor for all subsequent identity operations.

At step 902, the system queries an identity database using the phone number as the primary key. The phone number extracted from the device-specific data obtained in the preceding step is transmitted as a query parameter to a persistent data store that maintains phone-number-anchored identity profiles. The query seeks to determine whether an existing identity profile has been established for this phone number during prior interactions with the system, or whether this represents a first-time engagement requiring initialization of a new identity record. The identity database serves as the authoritative repository for accumulated contextual intelligence associated with each phone number identity, storing interaction history, device associations, communication preferences, opt-in state records, engagement patterns, confidence indicators, and behavioral observations that have been collected and updated across multiple prior verification events.

At step 903, the system evaluates whether a profile exists in the identity database for the queried phone number. This represents a conditional branching point in the method flow that determines whether the system proceeds to retrieve accumulated historical data for an established identity or initializes a new identity record for a previously unknown phone number. If an existing profile is found in the identity database, indicating that this phone number has participated in prior verification events and has accumulated contextual data, the method proceeds to step 905. If no existing profile is found, indicating that this phone number is engaging with the system for the first time and no prior interaction history exists, the method proceeds to step 904.

At step 904, executed only when no existing profile was found at step 903, the system creates a new identity profile anchored to the phone number. The newly initialized identity record establishes the phone number as the persistent identifier that will serve as the stable anchor for all future data accumulation associated with this user. The new profile is populated with the device-specific data obtained at step 901 as the initial contextual observations, including device type, platform information, geographic or network location, timestamp of first interaction, and the initiator identifier that triggered this engagement. The new profile is assigned initial default values for confidence indicators, engagement metrics, and opt-in state information, reflecting the absence of any accumulated verification history. Upon creation of the new identity profile, the method proceeds to step 906 for processing alongside profiles retrieved from the database.

At step 905, executed only when an existing profile was found at step 903, the system retrieves the accumulated profile data from the identity database. The retrieved data comprises the complete interaction history showing all prior verification events associated with this phone number identity, device associations documenting which devices and platforms have been used for prior interactions, opt-in state records showing the evolution of consent permissions over time, communication preference patterns derived from prior protocol selections and engagement behaviors, confidence indicators reflecting the assessed trustworthiness and verification depth of the identity based on historical consistency and validation outcomes, and engagement metrics quantifying the frequency, recency, and depth of prior system interactions. This retrieved accumulated data represents the compounded contextual intelligence that differentiates an established identity from a newly initialized identity, and serves as the primary input to the trust scoring computation that determines token parameter adjustments.

At step 906, the system merges the new contextual data obtained from the current interaction at step 901 with the identity profile, whether that profile was newly created at step 904 or retrieved from the database at step 905. The merge operation appends the current interaction to the interaction history, updates engagement metrics to reflect the new engagement event, records any new device associations if the current device differs from previously observed devices, captures the current timestamp and geographic or network location as a new data point in the location history, and updates any preference indicators based on implicit signals derived from the current interaction such as time of day, protocol used, or interaction speed. For newly created profiles proceeding from step 904, this merge operation establishes the first historical data point. For retrieved profiles proceeding from step 905, this merge operation compounds the newly acquired contextual data onto the existing accumulated intelligence, creating an ever-growing repository of identity context that improves in richness and predictive value with each successive interaction.

At step 907, the system applies inference logic to the updated identity profile and computes an identity confidence score. The inference logic evaluates the depth and quality of the accumulated verification history, analyzing factors including the number of prior successful verification events, the consistency of device associations and behavioral patterns across time, the recency and frequency of prior engagements, the geographic or network location stability indicating whether the user consistently engages from expected locations, the opt-in state progression showing whether the user has advanced through consent levels over time, and any anomalous patterns or inconsistencies that might indicate identity uncertainty or risk. The inference logic may incorporate machine learning algorithms, behavioral analytics, risk scoring models, or other computational intelligence techniques to extract trust indicators from the accumulated data. The output of this inference process is a computed identity confidence score, expressed as a numerical value or categorical classification, that quantifies the system's assessed level of certainty regarding the authenticity and trustworthiness of this phone number identity based on all available historical context. Users with rich, consistent, long-standing verification histories receive high confidence scores, while users with minimal or absent prior engagement receive low confidence scores, and users with inconsistent or anomalous patterns receive intermediate or flagged scores.

At step 908, the system applies the computed confidence score to access token parameters and adjusts the entropy and privilege level accordingly. The confidence score computed in the preceding step serves as a weighting factor that dynamically modifies the parameters of the access token to be generated, creating a trust-differentiated entitlement structure wherein token characteristics are not fixed by access rules alone but are instead adapted to reflect the accumulated trust context of the identity. For users with high confidence scores, the adjustments may include reducing the entropic complexity of the dynamically generated URL component to improve user experience while maintaining adequate security given the established trust context, elevating the privilege level encoded in the token to enable access to enhanced physical zones or expedited entry processes, extending the temporal validity window of the token based on the reduced perceived risk, and enabling additional features or capabilities within the token structure that are reserved for verified established identities. For users with low confidence scores, the adjustments may include increasing the entropic complexity of the token to provide stronger security protections given the absence of trust history, restricting the privilege level to basic access entitlements only, limiting the temporal validity window to require more frequent reverification, and disabling enhanced features or capabilities pending accumulation of additional verification history. For users with intermediate confidence scores or flagged patterns, the adjustments may include implementing moderate entropy and privilege configurations, requiring additional verification steps before token activation, or triggering manual review processes before access is granted.

At step 909, the system generates the identity-weighted access token incorporating the adjusted parameters determined in the preceding step. The generated token comprises a dynamically generated URL that encodes the access entitlement and serves as the activation mechanism, entropic values providing cryptographic security appropriate to the confidence level, the privilege tier reflecting the identity confidence score, temporal validity constraints defining when and for how long the token may be activated, session identifiers enabling tracking and attribution of the token usage, and any capability flags or feature enablements corresponding to the assigned privilege level. The generated token is structured such that its observable characteristics and functional capabilities directly reflect the trust weight derived from the phone number identity's accumulated verification history, creating a system wherein established users with proven engagement patterns receive functionally superior tokens while new or uncertain users receive more restrictive tokens, all determined algorithmically without requiring explicit manual review or classification of individual users.

At step 910, the system writes an enriched ledger entry to a distributed ledger. The ledger entry recorded at this step comprises not only the generated access token itself but additionally the identity confidence score that was computed at step 907 and applied to the token parameters at step 908, the messaging protocol that will be used for token delivery as determined through capability and opt-in evaluation, the opt-in state of the user at the time of token issuance reflecting the consent permissions governing messaging and access eligibility, the loyalty tier of the user if applicable reflecting any loyalty program standing associated with the phone number identity, timestamp information documenting when the token was generated, and the initiator identifier linking the token to the specific verification event or controlled physical location for which access is being granted. This enriched ledger entry creates an auditable trust evolution record that documents not only what access was granted but also the identity context and confidence assessment that informed that access decision, enabling retrospective analysis of how identity confidence correlates with actual access outcomes, supporting adaptive learning that refines confidence scoring algorithms over time, and providing event hosts with visibility into the trust foundation underlying each access grant. The use of a distributed ledger for this storage provides privacy compliance benefits, tamper-resistance, and distributed consensus regarding the recorded trust metadata.

At step 911, the system sends a tiered status notification to an event host and delivers the generated token to the mobile device. The tiered status notification transmitted to the event host comprises information indicating that a verification has been completed for a specific user identity, the privilege level assigned to the generated token reflecting the identity confidence score, any special handling instructions or flags associated with this access grant such as manual verification requirements or enhanced monitoring, and session or tracking identifiers enabling the event host to correlate the notification with subsequent token activation attempts. The status notification is described as “tiered” because it conveys not merely a binary approved or denied determination but rather communicates the specific privilege tier that has been assigned based on the identity-weighted evaluation, enabling the event host to provide differentiated access experiences such as routing users to different entry lanes, granting access to different physical zones within a controlled location, or applying different processing priorities based on the confidence-weighted privilege tier. Simultaneously, the generated access token is delivered to the mobile device using a messaging protocol determined through opt-in state and capability evaluation, enabling the user to activate the token and obtain access to the controlled physical location in accordance with the privilege level encoded within it and communicated to the event host via the tiered notification. The delivery to the mobile device may occur via Rich Communication Services, Short Message Service, or Multimedia Messaging Service depending on device capabilities, carrier support, and the user's opt-in state, as evaluated through processes that coordinate protocol eligibility determination and capability negotiation.

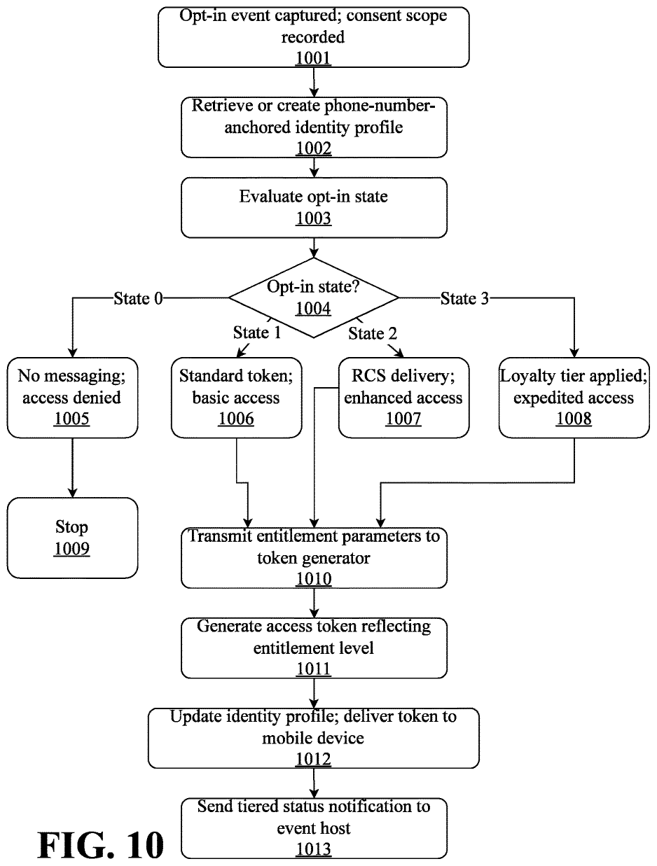

FIG. 10 is a method diagram illustrating steps for consent-gated access level determination using a multi-state opt-in model to govern physical access entitlement, according to an embodiment. The method demonstrates how the system evaluates a user's accumulated consent state and applies differentiated access privilege tiers based on the specific opt-in level achieved, wherein users progress through discrete consent states that unlock progressively enhanced messaging capabilities and elevated physical access entitlements, transforming opt-in from a binary permission flag into a graduated authorization structure that governs both communication eligibility and access control parameters.

At step 1001, an opt-in event is captured and the consent scope is recorded. The opt-in event is triggered by a user interaction with a digital activation asset such as a near-field communication beacon, quick-response code, call-to-action button, redirect link, or other initiator mechanism embedded in advertisements, invitations, physical media, or digital content. The captured opt-in event comprises identifying information including the phone number of the mobile device from which the interaction originated, an activation asset identifier that associates the opt-in with a specific campaign, product, service, or verification event, consent scope parameters that define the type and extent of messaging permissions being granted by the user's interaction, timestamp information documenting when the opt-in occurred, and contextual metadata such as device type, platform information, geographic or network location, and the source or medium through which the activation asset was presented. The consent scope parameters captured at this step define not merely whether the user has opted in but rather the specific level or tier of consent being established, enabling the system to differentiate between basic messaging consent, enhanced messaging capability consent, and verified identity with loyalty program participation, each of which maps to a corresponding access entitlement tier as determined through subsequent processing steps.

At step 1002, the system retrieves or creates a phone-number-anchored identity profile. Using the phone number captured in the opt-in event at step 1001 as the primary identifier, the system queries a persistent identity database to determine whether an existing identity profile has been established for this phone number during prior interactions with the system. If an existing profile is found, the system retrieves the accumulated data comprising prior opt-in records showing the history of consent state transitions, interaction history documenting all previous verification events and engagements, device associations linking the phone number identity to specific devices or platforms used in prior interactions, communication preference patterns derived from historical protocol selections and engagement behaviors, loyalty program standing if the identity has been associated with a loyalty management system, and confidence indicators reflecting the assessed trustworthiness and verification depth of the identity. If no existing profile is found, indicating that this phone number is engaging with the system for the first time, the system initializes a new identity record anchored to the phone number, populating the new profile with the contextual data captured during the current opt-in event as the initial data points and assigning default values for metrics that will be accumulated over time through future interactions. The phone number serves as the stable persistent identifier or identity anchor that enables the system to maintain continuity of consent state and accumulated context across multiple interactions, devices, sessions, and time periods.

At step 1003, the system evaluates the opt-in state of the user based on the captured opt-in event from step 1001 and the identity profile retrieved or created at step 1002. The evaluation process determines which of multiple discrete opt-in states applies to the current interaction by analyzing the consent scope parameters captured during the opt-in event, examining the opt-in state history recorded in the identity profile to identify any prior consent levels that have been established, assessing whether the current opt-in event represents an initial consent grant or an upgrade to a higher consent tier, applying any campaign-specific rules or verification requirements that condition advancement to elevated consent states, and considering temporal factors such as consent expiration or renewal requirements that may affect the current validity of previously granted consent. The opt-in state evaluation represents a critical classification step that determines the messaging eligibility and access privilege tier that will govern the remainder of the interaction, with the evaluation outcome directing the method flow to one of several distinct processing paths corresponding to the identified opt-in state.

At step 1004, the system determines which of four discrete opt-in states applies to the current interaction. This represents a multi-way conditional branching point in the method flow that routes processing to different paths based on the opt-in state classification determined at step 1003. The four possible states are: State 0, representing the absence of any opt-in or valid consent, wherein no messaging is permitted and no access token generation occurs; State 1, representing a basic opt-in level granting standard messaging permission and basic access entitlement; State 2, representing an enhanced messaging opt-in level permitting Rich Communication Services delivery and elevated access privilege; and State 3, representing a verified identity with loyalty program confirmation granting the highest tier of messaging capability and access entitlement including expedited entry and tier-based physical access zones. The branching logic at this step directs users in State 0 to step 1005 for denial or deferral processing, users in State 1 to step 1006 for standard token generation, users in State 2 to step 1007 for enhanced token generation with Rich Communication Services delivery, and users in State 3 to step 1008 for loyalty-augmented token generation with maximum privilege tier.

At step 1005, executed only for users classified as State 0 at step 1004, the system denies messaging permission and access entitlement. Users in State 0 have not granted valid consent for system engagement, either because they have never opted in, because their prior consent has expired or been revoked, or because the current interaction does not satisfy the threshold requirements for establishing even basic opt-in status. For these users, no access token is generated, no verification processing occurs, and no messaging is delivered beyond a denial or deferral notification explaining that access cannot be granted without appropriate consent. The method proceeds from this step to step 1009 where processing terminates without token generation or event host notification.

At step 1006, executed only for users classified as State 1 at step 1004, the system generates a standard token with basic access parameters. Users in State 1 have granted basic opt-in consent that permits standard messaging and authorizes basic access entitlement to the controlled physical location or verification event. The standard token generated for these users comprises a dynamically generated URL with moderate entropy appropriate to the basic trust tier, privilege level parameters that grant access to standard entry zones or processing lanes without expedited or enhanced treatment, temporal validity constraints appropriate to the basic consent scope, and session identifiers for tracking and attribution purposes. The token is prepared for delivery via Short Message Service or Multimedia Messaging Service, as Rich Communication Services delivery is reserved for users who have achieved State 2 or higher opt-in levels. Upon generating the standard token, the method proceeds to step 1010 for transmission of entitlement parameters to the token generation infrastructure and continuation of the delivery process.

At step 1007, executed only for users classified as State 2 at step 1004, the system enables Rich Communication Services delivery and generates an enhanced access token. Users in State 2 have achieved an enhanced messaging opt-in level through explicit consent upgrade, verification completion, or satisfaction of campaign-specific eligibility criteria that authorize the use of Rich Communication Services for message delivery. The enhanced token generated for these users comprises elevated privilege parameters that grant access to enhanced physical zones, expedited processing lanes, or additional capabilities beyond those available to State 1 users, increased temporal validity or reduced reverification requirements reflecting the elevated trust tier, and formatting appropriate for Rich Communication Services delivery including rich card layouts, interactive buttons, branded sender identity, and read receipt functionality. The authorization to use Rich Communication Services for token delivery represents a capability unlock that is gated by the achievement of State 2 or higher consent level, demonstrating how the opt-in state model serves as the governing structure for both messaging protocol eligibility and access privilege tier assignment. Upon generating the enhanced token, the method proceeds to step 1010 for transmission of entitlement parameters and continuation of the delivery process.

At step 1008, executed only for users classified as State 3 at step 1004, a loyalty tier is applied and an expedited access token is generated. Users in State 3 represent the highest consent and verification tier, having achieved verified identity status and confirmed participation in a loyalty program associated with their phone number identity. The loyalty tier application at this step incorporates loyalty standing information retrieved from a loyalty management system, including loyalty membership level, reward points balance, engagement value classification, or premium status indicators, and uses this loyalty context to further augment the access entitlement beyond the enhanced level granted to State 2 users. The expedited access token generated for State 3 users comprises maximum privilege tier parameters enabling expedited entry lanes, VIP or premium physical access zones, priority processing or queue bypass capabilities, loyalty-linked secondary access rights such as guest privileges or upgrade eligibility, dynamic seat or space upgrade entitlements based on loyalty standing, and any other differentiated treatment reserved for verified loyalty program participants. The token may additionally encode loyalty program benefits such as reward point accrual, exclusive offers, or promotional incentives that are delivered through the access token mechanism itself rather than requiring separate loyalty application interactions. The integration of loyalty management into the access control flow creates switching costs and ongoing engagement value that compounds over time alongside the accumulated identity and preference data maintained by the system. Upon generating the loyalty-augmented expedited access token, the method proceeds to step 1010 for transmission of entitlement parameters and continuation of the delivery process.

At step 1009, the method terminates without generating an access token or proceeding to event host notification. This termination step is reached only from step 1005 for users classified as State 0 who lack valid consent for system engagement. No token generation, identity profile updates, ledger recording, or event host communication occurs for these users, as the absence of opt-in consent precludes any further processing beyond the denial notification that may have been delivered at step 1005. The termination at this step represents the enforcement of consent-gated access control wherein the opt-in state serves as an absolute prerequisite for access entitlement consideration.

At step 1010, the system transmits entitlement parameters to a token generator. This step is reached from steps 1006, 1007, or 1008 depending on which opt-in state was identified at step 1004, and serves as the convergence point where differentiated entitlement parameters determined through the state-specific processing paths are forwarded to token generation infrastructure for final token assembly. The entitlement parameters transmitted at this step comprise the privilege tier corresponding to the opt-in state, indicating whether standard, enhanced, or expedited access should be encoded in the token, the messaging protocol selected for token delivery based on opt-in state and capability evaluation, indicating whether Short Message Service, Multimedia Messaging Service, or Rich Communication Services should be used, temporal validity constraints appropriate to the assigned privilege tier, session identifiers for tracking and attribution, loyalty augmentation parameters if applicable for State 3 users, and any special handling instructions or capability flags that should be incorporated into the token structure. The transmission of these parameters to the token generator enables the final assembly and formatting of the access token in accordance with the consent-gated entitlement tier that has been determined through the multi-state opt-in evaluation.

At step 1011, the system generates an access token reflecting the assigned entitlement level. The token generator receives the entitlement parameters transmitted at step 1010 and assembles a complete access token structure comprising a dynamically generated URL encoding the access entitlement and serving as the activation mechanism, entropic values providing cryptographic security appropriate to the privilege tier, privilege level indicators that will be recognized by the event host to determine what access should be granted upon token activation, temporal validity constraints defining the time window during which the token may be activated, session identifiers enabling tracking of token usage and attribution to the originating opt-in event and identity, and formatting or presentation elements appropriate to the messaging protocol that will be used for delivery. The generated token is structured such that its functional capabilities and access entitlements directly reflect the opt-in state classification determined earlier in the method flow, creating a system wherein advancement through consent states unlocks progressively enhanced token privileges without requiring explicit manual configuration or approval processes for individual users.

At step 1012, the system updates the identity profile and delivers the token to the mobile device. The identity profile retrieved or created at step 1002 is updated to reflect the current interaction, recording the opt-in state that was evaluated and applied, appending the current token generation event to the interaction history, updating engagement metrics to reflect the new engagement, capturing the assigned privilege tier and messaging protocol used for future reference, and documenting any loyalty tier application if applicable for State 3 users. This profile update ensures that the accumulated contextual intelligence associated with the phone number identity continues to grow with each interaction, enabling future interactions to benefit from the compounded consent state history and engagement patterns. Simultaneously, the generated access token is delivered to the mobile device using the messaging protocol corresponding to the user's opt-in state, with State 1 users receiving token delivery via Short Message Service or Multimedia Messaging Service, and State 2 or State 3 users receiving token delivery via Rich Communication Services where device capability and carrier support permit. The token delivery includes presentation appropriate to the selected protocol, with Rich Communication Services delivery incorporating rich card layouts, interactive activation buttons, and branded sender identity, while Short Message Service or Multimedia Messaging Service delivery adapts the presentation to plain text descriptions with numbered activation options while preserving the core activation mechanics and access entitlement.

At step 1013, the system sends a tiered status notification to an event host. The notification transmitted to the event host comprises information indicating that a consent-gated verification has been completed for a specific user identity, the privilege tier that has been assigned based on the opt-in state evaluation and any loyalty augmentation, indicating whether standard, enhanced, or expedited access should be provided, the messaging protocol used for token delivery which may inform the event host regarding the user's device capabilities and engagement level, session or tracking identifiers enabling the event host to correlate the notification with subsequent token activation attempts, and any special handling instructions such as loyalty program recognition, expedited entry lane routing, or enhanced physical zone access authorizations. The notification is described as “tiered” because it communicates not merely a binary approved or denied determination but rather conveys the specific privilege tier that has been assigned through the multi-state opt-in evaluation process, enabling the event host to provide differentiated access experiences wherein State 1 users are directed to standard entry points and granted basic access, State 2 users are directed to enhanced entry points and granted elevated access privileges, and State 3 users are directed to expedited or VIP entry points and granted maximum access privileges including loyalty-augmented entitlements. The event host provides access to the controlled physical location upon receipt of the tiered status notification and upon activation of the access token by the mobile device, with the nature and scope of that access determined by the privilege tier communicated in the notification rather than being uniform across all verified users.

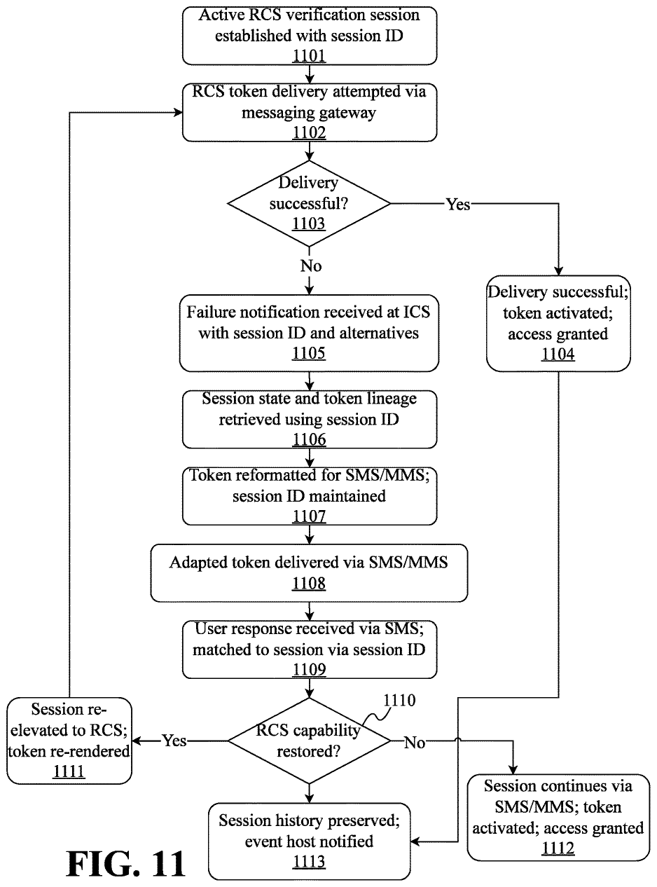

FIG. 11 is a method diagram illustrating steps for maintaining session continuity and seamless protocol fallback during access token delivery when Rich Communication Services capabilities become unavailable mid-verification, according to an embodiment. The method demonstrates how the system preserves interaction context, conversation history, token lineage, and user intent when transitioning between messaging protocols due to capability changes, delivery failures, or network constraints, ensuring uninterrupted verification flow and access token activation despite underlying technical disruptions while maintaining complete attribution and audit trails across protocol transitions.

At step 1101, an active Rich Communication Services verification session is established with a session identifier. The verification session is initiated when a user interacts with a near-field communication beacon or quick-response code initiator, triggering an auto-populated text message transmission from a mobile device that begins the identity verification and access token generation process. The session is established using Rich Communication Services as the messaging protocol based on prior evaluation of the user's opt-in state, device capabilities, and carrier support, indicating that enhanced messaging features including rich card layouts, interactive buttons, branded sender identity, and read receipt functionality are available and permitted for this interaction. The session identifier assigned at this step serves as a unique tracking token that threads through all subsequent operations within this verification interaction, enabling the system to maintain continuity of context, attribution, and state across multiple message exchanges, protocol transitions, and processing steps. The session identifier is stored in association with the user's phone-number-anchored identity profile, the initiator identifier that triggered the verification event, the current verification state indicating what information has been collected and what steps remain, the messaging protocol currently in use, the capability profile documenting which Rich Communication Services features are available, and timestamp information marking the session initiation.

At step 1102, Rich Communication Services token delivery is attempted via a messaging gateway. The system prepares an access token formatted for Rich Communication Services delivery, incorporating rich presentation elements including a rich card layout that structures the token information in an engaging visual format, an interactive activation button that enables single-tap token activation without requiring the user to copy URLs or navigate to external interfaces, branded sender identity elements displaying business name, logo, and verification badges to establish authenticity and trust, read receipt functionality enabling confirmation that the user has viewed the token, and any rich media content such as images, videos, or documents that provide additional context about the controlled physical location or verification event. The formatted token and delivery instructions, including the session identifier established at step 1101, are transmitted to a messaging gateway that interfaces with external Rich Communication Services platform services and carrier networks. The messaging gateway initiates the delivery process by connecting to carrier Rich Communication Services infrastructure, transmitting the formatted token message with all enhanced presentation features, and monitoring for delivery confirmation or failure notifications. The delivery attempt proceeds under the assumption that Rich Communication Services capabilities that were available and verified when the session was established at step 1101 remain available for continued use.

At step 1103, the system evaluates whether the delivery was successful. This represents a conditional branching point in the method flow that determines whether the Rich Communication Services token delivery completed successfully or encountered a failure condition. The evaluation examines delivery confirmation signals received from the messaging gateway, timeout conditions indicating that delivery confirmation was not received within expected timeframes, explicit error notifications from Rich Communication Services platform services indicating delivery failure, or network status indicators suggesting connectivity problems or service unavailability. If the delivery completed successfully, indicating that the token was transmitted to the mobile device via Rich Communication Services and delivery confirmation was received, the method proceeds to step 1104 where the token activation and access grant processes continue. If the delivery failed, indicating that the token could not be transmitted via Rich Communication Services due to capability unavailability, network issues, service disruptions, or device configuration changes, the method proceeds to step 1105 to initiate the protocol fallback process.

At step 1104, executed only when delivery was successful at step 1103, the delivery is confirmed as successful, the token is activated by the user, and access is granted. The user receives the Rich Communication Services token message on their mobile device with all enhanced presentation features intact, views the token information presented in the rich card layout, and activates the token by interacting with the provided activation button or mechanism. The activation signal is transmitted back through the messaging gateway to the interaction control server, which validates the token, confirms that the activation occurred within the temporal validity window, verifies that the activating device matches the device associated with the session identifier, and coordinates with an event host to provide access to the controlled physical location in accordance with the privilege level encoded in the token. The successful completion of the verification and access grant via Rich Communication Services represents the optimal path wherein enhanced messaging capabilities remain available throughout the interaction, providing the richest user experience and strongest verification assurances. Upon completion of the access grant at this step, the session may be closed and final audit records written, or the session may remain active for continued engagement depending on the access control scenario.

At step 1105, executed only when delivery failed at step 1103, a failure notification is received at the interaction control server with the session identifier and available alternatives. The messaging gateway detects the Rich Communication Services delivery failure through lack of confirmation, explicit error messages from platform services, timeout conditions, or network diagnostics, and generates a structured failure notification that is transmitted to the interaction control server. The failure notification comprises the session identifier that associates the failed delivery with the ongoing verification session established at step 1101, diagnostic information describing the nature and cause of the delivery failure such as device capability unavailability indicating that Rich Communication Services is no longer supported by the user's device or carrier configuration, service unavailability indicating temporary disruption of Rich Communication Services platform services or carrier network issues, network connectivity problems indicating broader data service interruptions affecting message delivery, or timeout conditions indicating that delivery could not be confirmed within expected timeframes. The failure notification additionally identifies available alternative messaging protocols that may be used for fallback delivery, typically Short Message Service or Multimedia Messaging Service, based on capability assessment indicating that these more basic protocols retain connectivity and delivery capability even as Rich Communication Services has become unavailable. The inclusion of the session identifier in the failure notification is critical to enabling the interaction control server to retrieve the complete session context and initiate seamless protocol transition without loss of verification state or user context.

At step 1106, the system retrieves session state and token lineage using the session identifier. Upon receiving the failure notification at step 1105, the interaction control server uses the session identifier as the retrieval key to query session state data stores and reconstruct the complete context of the verification interaction that is experiencing the delivery failure. The retrieved session state comprises the full interaction history showing all prior message exchanges, user responses, and processing steps that have occurred within this session, the current verification state documenting what identity information has been collected and validated, what access rules have been evaluated, and what token parameters have been determined, the user identity and phone-number-anchored profile data enabling correlation of this session with the persistent identity record, the original initiator identifier linking the session to the specific verification event or controlled physical location for which access is being sought, the token lineage documenting the access token that was generated and prepared for delivery, including all privilege parameters, entropy values, temporal constraints, and entitlement data encoded within it, the messaging protocol and capability profile that were in use when the session was established, campaign and attribution metadata linking the session to specific marketing initiatives or activation assets, and timestamp information documenting the session timeline and enabling evaluation of temporal validity constraints. This comprehensive retrieval ensures that the session can continue seamlessly despite the protocol transition, with no loss of context, no requirement for the user to restart the verification process or re-provide information, and no disruption to the intended access control outcome. The token lineage retrieved at this step is particularly important because it enables the system to preserve the exact same access entitlement, privilege tier, and token parameters that were determined through the verification processing, ensuring that the protocol fallback affects only the delivery mechanism and presentation format while maintaining complete functional equivalence of the access grant.

At step 1107, the token is reformatted for Short Message Service or Multimedia Messaging Service delivery while the session identifier is maintained. The interaction control server, utilizing the token lineage and session context retrieved at step 1106, automatically adapts the Rich Communication Services token that failed to deliver into a version compatible with Short Message Service or Multimedia Messaging Service protocols. The reformatting process involves converting the rich card layout into a plain text description that conveys the same essential information regarding the access token, the verification event, and the activation mechanism in a linear format suitable for Short Message Service display constraints, replacing the interactive activation button with text-based activation instructions that may include a clickable URL encoded in the message body or numbered reply options that enable activation through standard Short Message Service reply functionality, preserving branded sender identification by including business name and verification context as text within the message body or utilizing sender name fields as protocol capabilities permit, simplifying or omitting rich media content that cannot be delivered via Short Message Service, or converting to Multimedia Messaging Service if images or limited media can be included while maintaining broad device compatibility, and restructuring the message presentation to maintain the same token activation mechanics and access entitlement while adapting to the constraints of the fallback protocol. Throughout this reformatting process, the core token parameters including the dynamically generated URL, entropic values, privilege tier, temporal validity constraints, and session identifier remain unchanged, ensuring functional equivalence between the Rich Communication Services version that failed to deliver and the Short Message Service or Multimedia Messaging Service version that will be transmitted as fallback. The preservation of the session identifier through the reformatting process is essential to maintaining attribution, audit trail continuity, and the ability to correlate the fallback delivery with the original verification session, enabling the system to treat the interaction as a continuous conversation thread despite the underlying protocol change.

At step 1108, the adapted token is delivered via Short Message Service or Multimedia Messaging Service. The reformatted token message prepared at step 1107 is transmitted to the messaging gateway with instructions to deliver via Short Message Service or Multimedia Messaging Service protocols. The messaging gateway delivers the message using standard Short Message Service or Multimedia Messaging Service infrastructure, which has broader compatibility and reliability than Rich Communication Services but lacks the enhanced presentation features and interactive capabilities. The message is transmitted to the user's mobile device phone number using carrier Short Message Service or Multimedia Messaging Service routing, with delivery proceeding through conventional text messaging channels that do not require Rich Communication Services platform participation or device-specific capability support. The user receives the adapted token message on their mobile device, experiencing the token presentation in simplified text format rather than the rich card layout that was intended for Rich Communication Services delivery, but retaining complete functional capability to activate the token and obtain access to the controlled physical location. The delivery via Short Message Service or Multimedia Messaging Service occurs transparently from the user's perspective, with the protocol transition happening in the background without requiring any explicit user action, acknowledgment, or awareness that a delivery failure and fallback process occurred.

At step 1109, a user response is received via Short Message Service and matched to the session via the session identifier. The user interacts with the adapted token message delivered at step 1108, which may involve clicking or tapping the activation URL encoded in the text message, sending a reply message containing a numbered option corresponding to token activation instructions, typing and transmitting a reply with activation confirmation text, or taking other actions enabled by the text-based activation mechanism provided in the adapted message format. The user's response or activation signal is transmitted from the mobile device using standard Short Message Service reply functionality and is received by the messaging gateway. The messaging gateway captures the inbound Short Message Service message and forwards it to the interaction control server along with the session identifier that was maintained through the reformatting process at step 1107 and embedded in or associated with the adapted token message delivered at step 1108. The session identifier serves as the critical linkage mechanism that enables the interaction control server to associate this Short Message Service response with the ongoing verification session that was originally established using Rich Communication Services at step 1101, underwent a protocol transition due to delivery failure at steps 1105 through 1108, and is now continuing via the fallback protocol. Without the session identifier continuity maintained through the protocol transition, the system would be unable to correlate the user's Short Message Service response with the original verification context, potentially requiring session restart or loss of verification state.

At step 1110, the system evaluates whether Rich Communication Services capability has been restored. This represents a conditional branching point in the method flow that determines whether the Rich Communication Services delivery failure that triggered the protocol fallback was temporary and has since been resolved, or whether the session should continue via Short Message Service or Multimedia Messaging Service for its remaining duration. The evaluation may involve querying Rich Communication Services capability endpoints to determine current capability status for the user's phone number, examining network status indicators or platform service health metrics to assess whether the service disruption or connectivity problem that caused the initial failure has been resolved, consulting cached capability profiles to identify whether device configuration or carrier network changes suggest restored Rich Communication Services support, analyzing elapsed time since the failure to apply heuristics regarding temporary versus persistent capability loss, or detecting explicit capability restoration signals from the messaging gateway or Rich Communication Services platform interface. If the evaluation determines that Rich Communication Services capability has been restored and is available for subsequent message exchanges within this session, the method proceeds to step 1111 to transition the session back to Rich Communication Services protocol. If the evaluation determines that Rich Communication Services remains unavailable or that the failure condition persists, the method proceeds to step 1112 to continue the session via the Short Message Service or Multimedia Messaging Service fallback protocol.

At step 1111, executed only when Rich Communication Services capability was determined to be restored at step 1110, the session is re-elevated to Rich Communication Services and the token is re-rendered. The interaction control server, having confirmed that Rich Communication Services delivery is once again available for the user's device and carrier configuration, initiates a protocol transition back to Rich Communication Services for subsequent message exchanges within this session. Any follow-up messages, confirmation notifications, or continued engagement communications that are part of the ongoing verification or access control interaction are reformatted from the adapted Short Message Service or Multimedia Messaging Service presentation back to Rich Communication Services rich card layouts with interactive buttons, branded sender identity, and enhanced features. The token itself may be re-rendered and retransmitted in Rich Communication Services format if additional token interactions or confirmations are required as part of the access control flow, or if the user requests retransmission for any reason. The session identifier continues to thread through the re-elevated Rich Communication Services messages, maintaining continuity of the conversation thread and attribution despite the bidirectional protocol transitions that have occurred during this single verification session. The ability to transition back to Rich Communication Services when capabilities are restored ensures that users experience optimal messaging features whenever technically feasible, while the robustness of the fallback mechanisms demonstrated in prior steps ensures that verification and access control operations are never blocked by temporary capability unavailability.

At step 1112, executed only when Rich Communication Services capability was determined to remain unavailable at step 1110, the session continues via Short Message Service or Multimedia Messaging Service, the token is activated, and access is granted. The verification and access control interaction proceeds to completion using the Short Message Service or Multimedia Messaging Service fallback protocol that was initiated at steps 1107 and 1108. The interaction control server processes the user's activation response received at step 1109, validates the token using the token lineage and session context preserved through the protocol transition, confirms that the activation occurred within the temporal validity window established when the token was originally generated, verifies that the activating device matches the device and identity associated with the session, and coordinates with an event host to provide access to the controlled physical location in accordance with the privilege level encoded in the token. The access grant proceeds with identical functional outcome and entitlement level as would have been provided had the Rich Communication Services delivery succeeded at step 1103, demonstrating that the protocol fallback process preserves complete functional equivalence of the verification outcome despite the simplified message presentation necessitated by Short Message Service or Multimedia Messaging Service constraints. The user successfully activates the token and obtains access to the controlled physical location, experiencing seamless continuation of the verification flow without awareness of the delivery failure and protocol transition that occurred transparently in the background.

At step 1113, session history is preserved and the event host is notified. Upon completion of the verification and access control interaction, whether through successful Rich Communication Services delivery at step 1104, through Short Message Service or Multimedia Messaging Service fallback completion at step 1112, or through re-elevated Rich Communication Services completion following step 1111, the complete session history is preserved in persistent data stores for analytics, audit, compliance, and future reference purposes. The preserved session history comprises all messages exchanged regardless of protocol used, documenting both Rich Communication Services messages sent prior to the delivery failure and Short Message Service or Multimedia Messaging Service messages exchanged during and after the fallback process, complete documentation of the protocol transition events including the delivery failure notification, the session state retrieval, the token reformatting, the fallback delivery, and any subsequent re-elevation to Rich Communication Services if capability was restored, user responses and activation signals captured across both Rich Communication Services and Short Message Service or Multimedia Messaging Service segments of the conversation, the session identifier that threaded through all processing steps and protocol transitions maintaining attribution continuity, token lineage documenting the access token generation, delivery attempts via multiple protocols, and ultimate activation, timestamp information marking all significant events within the session lifecycle, and outcome or disposition information indicating whether access was granted, what privilege tier was applied, and through which protocol the successful token activation ultimately occurred. This comprehensive session history preservation enables detailed analytics showing the full user journey despite protocol variations, supports downstream systems and event hosts with complete context documenting how verification was achieved and what delivery challenges were overcome, maintains compliance and audit trails required for access control documentation and regulatory purposes, informs future optimization of capability evaluation, protocol selection, and fallback strategies by providing empirical data on delivery success rates and protocol reliability patterns, and enables correlation of delivery failures with specific network conditions, device types, carrier configurations, or temporal patterns to drive continuous improvement of the verification system's resilience and reliability. The event host is notified upon session completion that access has been granted for the verified user identity, receiving information regarding the privilege tier applied, the session identifier for correlation with physical access system logs, confirmation that token activation was successful despite any intermediate protocol transitions, and any relevant metadata regarding the verification path taken or special conditions encountered during the session. The event host provides physical access to the controlled location in accordance with the verified entitlement, completing the access control operation that was initiated when the user first interacted with the near-field communication beacon or quick-response code initiator at step 1101, with the entire verification flow having been preserved through protocol transition challenges that could otherwise have disrupted the user experience or prevented successful access grant.

### Exemplary Computing Environment

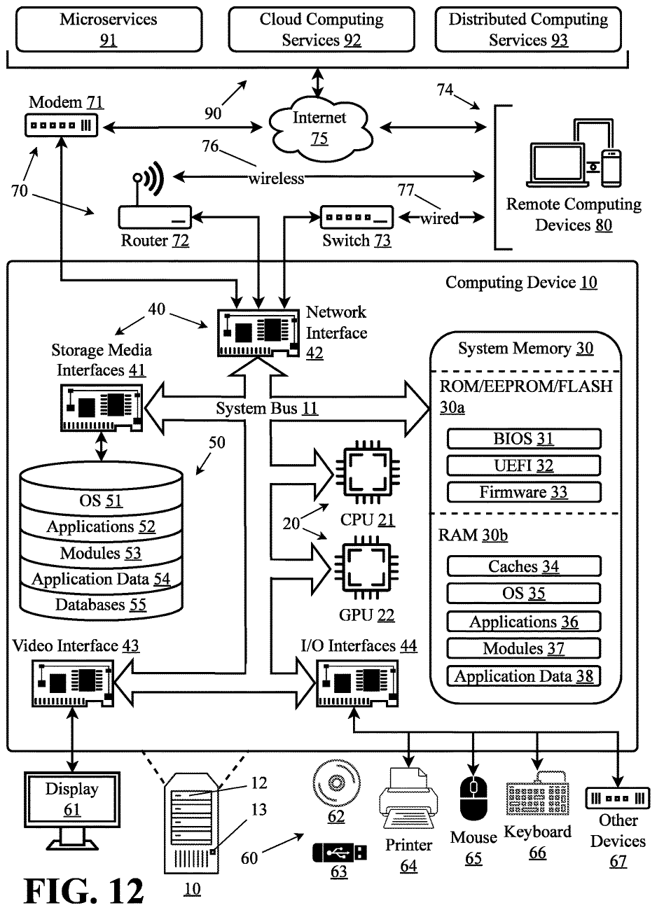

FIG. 12 illustrates an exemplary computing environment on which an embodiment described herein may be implemented, in full or in part. This exemplary computing environment describes computer-related components and processes supporting enabling disclosure of computer-implemented embodiments. Inclusion in this exemplary computing environment of well-known processes and computer components, if any, is not a suggestion or admission that any embodiment is no more than an aggregation of such processes or components. Rather, implementation of an embodiment using processes and components described in this exemplary computing environment will involve programming or configuration of such processes and components resulting in a machine specially programmed or configured for such implementation. The exemplary computing environment described herein is only one example of such an environment and other configurations of the components and processes are possible, including other relationships between and among components, and/or absence of some processes or components described. Further, the exemplary computing environment described herein is not intended to suggest any limitation as to the scope of use or functionality of any embodiment implemented, in whole or in part, on components or processes described herein.

The exemplary computing environment described herein comprises a computing device 10 (further comprising a system bus 11, one or more processors 20, a system memory 30, one or more interfaces 40, one or more non-volatile data storage devices 50), external peripherals and accessories 60, external communication devices 70, remote computing devices 80, and cloud-based services 90.

System bus 11 couples the various system components, coordinating operation of and data transmission between those various system components. System bus 11 represents one or more of any type or combination of types of wired or wireless bus structures including, but not limited to, memory busses or memory controllers, point-to-point connections, switching fabrics, peripheral busses, accelerated graphics ports, and local busses using any of a variety of bus architectures. By way of example, such architectures include, but are not limited to, Industry Standard Architecture (ISA) busses, Micro Channel Architecture (MCA) busses, Enhanced ISA (EISA) busses, Video Electronics Standards Association (VESA) local busses, a Peripheral Component Interconnects (PCI) busses also known as a Mezzanine busses, or any selection of, or combination of, such busses. Depending on the specific physical implementation, one or more of the processors 20, system memory 30 and other components of the computing device 10 can be physically co-located or integrated into a single physical component, such as on a single chip. In such a case, some or all of system bus 11 can be electrical pathways within a single chip structure.

Computing device may further comprise externally-accessible data input and storage devices 12 such as compact disc read-only memory (CD-ROM) drives, digital versatile discs (DVD), or other optical disc storage for reading and/or writing optical discs 62; magnetic cassettes, magnetic tape, magnetic disk storage, or other magnetic storage devices; or any other medium which can be used to store the desired content and which can be accessed by the computing device 10. Computing device may further comprise externally-accessible data ports or connections 12 such as serial ports, parallel ports, universal serial bus (USB) ports, and infrared ports and/or transmitter/receivers. Computing device may further comprise hardware for wireless communication with external devices such as IEEE 1394 (“Firewire”) interfaces, IEEE 802.11 wireless interfaces, BLUETOOTH® wireless interfaces, and so forth. Such ports and interfaces may be used to connect any number of external peripherals and accessories 60 such as visual displays, monitors, and touch-sensitive screens 61, USB solid state memory data storage drives (commonly known as “flash drives” or “thumb drives”) 63, printers 64, pointers and manipulators such as mice 65, keyboards 66, and other devices 67 such as joysticks and gaming pads, touchpads, additional displays and monitors, and external hard drives (whether solid state or disc-based), microphones, speakers, cameras, and optical scanners.

Processors 20 are logic circuitry capable of receiving programming instructions and processing (or executing) those instructions to perform computer operations such as retrieving data, storing data, and performing mathematical calculations. Processors 20 are not limited by the materials from which they are formed or the processing mechanisms employed therein, but are typically comprised of semiconductor materials into which many transistors are formed together into logic gates on a chip (i.e., an integrated circuit or IC). The term processor includes any device capable of receiving and processing instructions including, but not limited to, processors operating on the basis of quantum computing, optical computing, mechanical computing (e.g., using nanotechnology entities to transfer data), and so forth. Depending on configuration, computing device 10 may comprise more than one processor. For example, computing device 10 may comprise one or more central processing units (CPUs) 21, each of which itself has multiple processors or multiple processing cores, each capable of independently or semi-independently processing programming instructions based on technologies like complex instruction set computer (CISC) or reduced instruction set computer (RISC). Further, computing device 10 may comprise one or more specialized processors such as a graphics processing unit (GPU) 22 configured to accelerate processing of computer graphics and images via a large array of specialized processing cores arranged in parallel. Further computing device 10 may be comprised of one or more specialized processes such as Intelligent Processing Units, field-programmable gate arrays or application-specific integrated circuits for specific tasks or types of tasks. The term processor may further include: neural processing units (NPUs) or neural computing units optimized for machine learning and artificial intelligence workloads using specialized architectures and data paths; tensor processing units (TPUs) designed to efficiently perform matrix multiplication and convolution operations used heavily in neural networks and deep learning applications; application-specific integrated circuits (ASICs) implementing custom logic for domain-specific tasks; application-specific instruction set processors (ASIPs) with instruction sets tailored for particular applications; field-programmable gate arrays (FPGAs) providing reconfigurable logic fabric that can be customized for specific processing tasks; processors operating on emerging computing paradigms such as quantum computing, optical computing, mechanical computing (e.g., using nanotechnology entities to transfer data), and so forth. Depending on configuration, computing device 10 may comprise one or more of any of the above types of processors in order to efficiently handle a variety of general purpose and specialized computing tasks. The specific processor configuration may be selected based on performance, power, cost, or other design constraints relevant to the intended application of computing device 10.

System memory 30 is processor-accessible data storage in the form of volatile and/or nonvolatile memory. System memory 30 may be either or both of two types: non-volatile memory and volatile memory. Non-volatile memory 30a is not erased when power to the memory is removed, and includes memory types such as read only memory (ROM), electronically-erasable programmable memory (EEPROM), and rewritable solid state memory (commonly known as “flash memory”). Non-volatile memory 30a is typically used for long-term storage of a basic input/output system (BIOS) 31, containing the basic instructions, typically loaded during computer startup, for transfer of information between components within computing device, or a unified extensible firmware interface (UEFI), which is a modern replacement for BIOS that supports larger hard drives, faster boot times, more security features, and provides native support for graphics and mouse cursors. Non-volatile memory 30a may also be used to store firmware comprising a complete operating system 35 and applications 36 for operating computer-controlled devices. The firmware approach is often used for purpose-specific computer-controlled devices such as appliances and Internet-of-Things (IoT) devices where processing power and data storage space is limited. Volatile memory 30b is erased when power to the memory is removed and is typically used for short-term storage of data for processing. Volatile memory 30b includes memory types such as random-access memory (RAM), and is normally the primary operating memory into which the operating system 35, applications 36, program modules 37, and application data 38 are loaded for execution by processors 20. Volatile memory 30b is generally faster than non-volatile memory 30a due to its electrical characteristics and is directly accessible to processors 20 for processing of instructions and data storage and retrieval. Volatile memory 30b may comprise one or more smaller cache memories which operate at a higher clock speed and are typically placed on the same IC as the processors to improve performance.

There are several types of computer memory, each with its own characteristics and use cases. System memory 30 may be configured in one or more of the several types described herein, including high bandwidth memory (HBM) and advanced packaging technologies like chip-on-wafer-on-substrate (CoWoS). Static random access memory (SRAM) provides fast, low-latency memory used for cache memory in processors, but is more expensive and consumes more power compared to dynamic random access memory (DRAM). SRAM retains data as long as power is supplied. DRAM is the main memory in most computer systems and is slower than SRAM but cheaper and more dense. DRAM requires periodic refresh to retain data. NAND flash is a type of non-volatile memory used for storage in solid state drives (SSDs) and mobile devices and provides high density and lower cost per bit compared to DRAM with the trade-off of slower write speeds and limited write endurance. HBM is an emerging memory technology that provides high bandwidth and low power consumption which stacks multiple DRAM dies vertically, connected by through-silicon vias (TSVs). HBM offers much higher bandwidth (up to 1 TB/s) compared to traditional DRAM and may be used in high-performance graphics cards, AI accelerators, and edge computing devices. Advanced packaging and CoWoS are technologies that enable the integration of multiple chips or dies into a single package. CoWoS is a 2.5D packaging technology that interconnects multiple dies side-by-side on a silicon interposer and allows for higher bandwidth, lower latency, and reduced power consumption compared to traditional PCB-based packaging. This technology enables the integration of heterogeneous dies (e.g., CPU, GPU, HBM) in a single package and may be used in high-performance computing, AI accelerators, and edge computing devices.

Interfaces 40 may include, but are not limited to, storage media interfaces 41, network interfaces 42, display interfaces 43, and input/output interfaces 44. Storage media interface 41 provides the necessary hardware interface for loading data from non-volatile data storage devices 50 into system memory 30 and storage data from system memory 30 to non-volatile data storage device 50. Network interface 42 provides the necessary hardware interface for computing device 10 to communicate with remote computing devices 80 and cloud-based services 90 via one or more external communication devices 70. Display interface 43 allows for connection of displays 61, monitors, touchscreens, and other visual input/output devices. Display interface 43 may include a graphics card for processing graphics-intensive calculations and for handling demanding display requirements. Typically, a graphics card includes a graphics processing unit (GPU) and video RAM (VRAM) to accelerate display of graphics. In some high-performance computing systems, multiple GPUs may be connected using NVLink bridges, which provide high-bandwidth, low-latency interconnects between GPUs. NVLink bridges enable faster data transfer between GPUs, allowing for more efficient parallel processing and improved performance in applications such as machine learning, scientific simulations, and graphics rendering. One or more input/output (I/O) interfaces 44 provide the necessary support for communications between computing device 10 and any external peripherals and accessories 60. For wireless communications, the necessary radio-frequency hardware and firmware may be connected to I/O interface 44 or may be integrated into I/O interface 44. Network interface 42 may support various communication standards and protocols, such as Ethernet and Small Form-Factor Pluggable (SFP). Ethernet is a widely used wired networking technology that enables local area network (LAN) communication. Ethernet interfaces typically use RJ45 connectors and support data rates ranging from 10 Mbps to 100 Gbps, with common speeds being 100 Mbps, 1 Gbps, 10 Gbps, 25 Gbps, 40 Gbps, and 100 Gbps. Ethernet is known for its reliability, low latency, and cost-effectiveness, making it a popular choice for home, office, and data center networks. SFP is a compact, hot-pluggable transceiver used for both telecommunication and data communications applications. SFP interfaces provide a modular and flexible solution for connecting network devices, such as switches and routers, to fiber optic or copper networking cables. SFP transceivers support various data rates, ranging from 100 Mbps to 100 Gbps, and can be easily replaced or upgraded without the need to replace the entire network interface card. This modularity allows for network scalability and adaptability to different network requirements and fiber types, such as single-mode or multi-mode fiber.

Non-volatile data storage devices 50 are typically used for long-term storage of data. Data on non-volatile data storage devices 50 is not erased when power to the non-volatile data storage devices 50 is removed. Non-volatile data storage devices 50 may be implemented using any technology for non-volatile storage of content including, but not limited to, CD-ROM drives, digital versatile discs (DVD), or other optical disc storage; magnetic cassettes, magnetic tape, magnetic disc storage, or other magnetic storage devices; solid state memory technologies such as EEPROM or flash memory; or other memory technology or any other medium which can be used to store data without requiring power to retain the data after it is written. Non-volatile data storage devices 50 may be non-removable from computing device 10 as in the case of internal hard drives, removable from computing device 10 as in the case of external USB hard drives, or a combination thereof, but computing device will typically comprise one or more internal, non-removable hard drives using either magnetic disc or solid state memory technology. Non-volatile data storage devices 50 may be implemented using various technologies, including hard disk drives (HDDs) and solid-state drives (SSDs). HDDs use spinning magnetic platters and read/write heads to store and retrieve data, while SSDs use NAND flash memory. SSDs offer faster read/write speeds, lower latency, and better durability due to the lack of moving parts, while HDDs typically provide higher storage capacities and lower cost per gigabyte. NAND flash memory comes in different types, such as Single-Level Cell (SLC), Multi-Level Cell (MLC), Triple-Level Cell (TLC), and Quad-Level Cell (QLC), each with trade-offs between performance, endurance, and cost. Storage devices connect to the computing device 10 through various interfaces, such as SATA, NVMe, and PCIe. SATA is the traditional interface for HDDs and SATA SSDs, while NVMe (Non-Volatile Memory Express) is a newer, high-performance protocol designed for SSDs connected via PCIe. PCIe SSDs offer the highest performance due to the direct connection to the PCIe bus, bypassing the limitations of the SATA interface. Other storage form factors include M.2 SSDs, which are compact storage devices that connect directly to the motherboard using the M.2 slot, supporting both SATA and NVMe interfaces. Additionally, technologies like Intel Optane memory combine 3D XPoint technology with NAND flash to provide high-performance storage and caching solutions. Non-volatile data storage devices 50 may be non-removable from computing device 10, as in the case of internal hard drives, removable from computing device 10, as in the case of external USB hard drives, or a combination thereof. However, computing devices will typically comprise one or more internal, non-removable hard drives using either magnetic disc or solid-state memory technology. Non-volatile data storage devices 50 may store any type of data including, but not limited to, an operating system 51 for providing low-level and mid-level functionality of computing device 10, applications 52 for providing high-level functionality of computing device 10, program modules 53 such as containerized programs or applications, or other modular content or modular programming, application data 54, and databases 55 such as relational databases, non-relational databases, object oriented databases, NoSQL databases, vector databases, knowledge graph databases, key-value databases, document oriented data stores, and graph databases.

Applications (also known as computer software or software applications) are sets of programming instructions designed to perform specific tasks or provide specific functionality on a computer or other computing devices. Applications are typically written in high-level programming languages such as C, C++, Scala, Erlang, GoLang, Java, Scala, Rust, and Python, which are then either interpreted at runtime or compiled into low-level, binary, processor-executable instructions operable on processors 20. Applications may be containerized so that they can be run on any computer hardware running any known operating system. Containerization of computer software is a method of packaging and deploying applications along with their operating system dependencies into self-contained, isolated units known as containers. Containers provide a lightweight and consistent runtime environment that allows applications to run reliably across different computing environments, such as development, testing, and production systems facilitated by specifications such as containerd.

The memories and non-volatile data storage devices described herein do not include communication media. Communication media are means of transmission of information such as modulated electromagnetic waves or modulated data signals configured to transmit, not store, information. By way of example, and not limitation, communication media includes wired communications such as sound signals transmitted to a speaker via a speaker wire, and wireless communications such as acoustic waves, radio frequency (RF) transmissions, infrared emissions, and other wireless media.

External communication devices 70 are devices that facilitate communications between computing device and either remote computing devices 80, or cloud-based services 90, or both. External communication devices 70 include, but are not limited to, data modems 71 which facilitate data transmission between computing device and the Internet 75 via a common carrier such as a telephone company or internet service provider (ISP), routers 72 which facilitate data transmission between computing device and other devices, and switches 73 which provide direct data communications between devices on a network or optical transmitters (e.g., lasers). Here, modem 71 is shown connecting computing device 10 to both remote computing devices 80 and cloud-based services 90 via the Internet 75. While modem 71, router 72, and switch 73 are shown here as being connected to network interface 42, many different network configurations using external communication devices 70 are possible. Using external communication devices 70, networks may be configured as local area networks (LANs) for a single location, building, or campus, wide area networks (WANs) comprising data networks that extend over a larger geographical area, and virtual private networks (VPNs) which can be of any size but connect computers via encrypted communications over public networks such as the Internet 75. As just one exemplary network configuration, network interface 42 may be connected to switch 73 which is connected to router 72 which is connected to modem 71 which provides access for computing device 10 to the Internet 75. Further, any combination of wired 77 or wireless 76 communications between and among computing device 10, external communication devices 70, remote computing devices 80, and cloud-based services 90 may be used. Remote computing devices 80, for example, may communicate with computing device through a variety of communication channels 74 such as through switch 73 via a wired 77 connection, through router 72 via a wireless connection 76, or through modem 71 via the Internet 75. Furthermore, while not shown here, other hardware that is specifically designed for servers or networking functions may be employed. For example, secure socket layer (SSL) acceleration cards can be used to offload SSL encryption computations, and transmission control protocol/internet protocol (TCP/IP) offload hardware and/or packet classifiers on network interfaces 42 may be installed and used at server devices or intermediate networking equipment (e.g., for deep packet inspection).

In a networked environment, certain components of computing device 10 may be fully or partially implemented on remote computing devices 80 or cloud-based services 90. Data stored in non-volatile data storage device 50 may be received from, shared with, duplicated on, or offloaded to a non-volatile data storage device on one or more remote computing devices 80 or in a cloud computing service 92. Processing by processors 20 may be received from, shared with, duplicated on, or offloaded to processors of one or more remote computing devices 80 or in a distributed computing service 93. By way of example, data may reside on a cloud computing service 92, but may be usable or otherwise accessible for use by computing device 10. Also, certain processing subtasks may be sent to a microservice 91 for processing with the result being transmitted to computing device 10 for incorporation into a larger processing task. Also, while components and processes of the exemplary computing environment are illustrated herein as discrete units (e.g., OS 51 being stored on non-volatile data storage device 51 and loaded into system memory 35 for use) such processes and components may reside or be processed at various times in different components of computing device 10, remote computing devices 80, and/or cloud-based services 90. Also, certain processing subtasks may be sent to a microservice 91 for processing with the result being transmitted to computing device 10 for incorporation into a larger processing task. Infrastructure as Code (IaaC) tools like Terraform can be used to manage and provision computing resources across multiple cloud providers or hyperscalers. This allows for workload balancing based on factors such as cost, performance, and availability. For example, Terraform can be used to automatically provision and scale resources on AWS spot instances during periods of high demand, such as for surge rendering tasks, to take advantage of lower costs while maintaining the required performance levels. In the context of rendering, tools like Blender can be used for object rendering of specific elements, such as a car, bike, or house. These elements can be approximated and roughed in using techniques like bounding box approximation or low-poly modeling to reduce the computational resources required for initial rendering passes. The rendered elements can then be integrated into the larger scene or environment as needed, with the option to replace the approximated elements with higher-fidelity models as the rendering process progresses.

In an implementation, the disclosed systems and methods may utilize, at least in part, containerization techniques to execute one or more processes and/or steps disclosed herein. Containerization is a lightweight and efficient virtualization technique that allows you to package and run applications and their dependencies in isolated environments called containers. One of the most popular containerization platforms is containerd, which is widely used in software development and deployment. Containerization, particularly with open-source technologies like containerd and container orchestration systems like Kubernetes, is a common approach for deploying and managing applications. Containers are created from images, which are lightweight, standalone, and executable packages that include application code, libraries, dependencies, and runtime. Images are often built from a containerfile or similar, which contains instructions for assembling the image. Containerfiles are configuration files that specify how to build a container image. Systems like Kubernetes natively support containerd as a container runtime. They include commands for installing dependencies, copying files, setting environment variables, and defining runtime configurations. Container images can be stored in repositories, which can be public or private. Organizations often set up private registries for security and version control using tools such as Harbor, JFrog Artifactory and Bintray, GitLab Container Registry, or other container registries. Containers can communicate with each other and the external world through networking. Containerd provides a default network namespace, but can be used with custom network plugins. Containers within the same network can communicate using container names or IP addresses.

Remote computing devices 80 are any computing devices not part of computing device 10. Remote computing devices 80 include, but are not limited to, personal computers, server computers, thin clients, thick clients, personal digital assistants (PDAs), mobile telephones, watches, tablet computers, laptop computers, multiprocessor systems, microprocessor based systems, set-top boxes, programmable consumer electronics, video game machines, game consoles, portable or handheld gaming units, network terminals, desktop personal computers (PCs), minicomputers, mainframe computers, network nodes, virtual reality or augmented reality devices and wearables, and distributed or multi-processing computing environments. While remote computing devices 80 are shown for clarity as being separate from cloud-based services 90, cloud-based services 90 are implemented on collections of networked remote computing devices 80.

Cloud-based services 90 are Internet-accessible services implemented on collections of networked remote computing devices 80. Cloud-based services are typically accessed via application programming interfaces (APIs) which are software interfaces which provide access to computing services within the cloud-based service via API calls, which are pre-defined protocols for requesting a computing service and receiving the results of that computing service. While cloud-based services may comprise any type of computer processing or storage, three common categories of cloud-based services 90 are serverless logic apps, microservices 91, cloud computing services 92, and distributed computing services 93.

Microservices 91 are collections of small, loosely coupled, and independently deployable computing services. Each microservice represents a specific computing functionality and runs as a separate process or container. Microservices promote the decomposition of complex applications into smaller, manageable services that can be developed, deployed, and scaled independently. These services communicate with each other through well-defined application programming interfaces (APIs), typically using lightweight protocols like HTTP, protobuffers, gRPC or message queues such as Kafka. Microservices 91 can be combined to perform more complex or distributed processing tasks. In an embodiment, Kubernetes clusters with containerized resources are used for operational packaging of system.

Cloud computing services 92 are delivery of computing resources and services over the Internet 75 from a remote location. Cloud computing services 92 provide additional computer hardware and storage on as-needed or subscription basis. Cloud computing services 92 can provide large amounts of scalable data storage, access to sophisticated software and powerful server-based processing, or entire computing infrastructures and platforms. For example, cloud computing services can provide virtualized computing resources such as virtual machines, storage, and networks, platforms for developing, running, and managing applications without the complexity of infrastructure management, and complete software applications over public or private networks or the Internet on a subscription or alternative licensing basis, or consumption or ad-hoc marketplace basis, or combination thereof.

Distributed computing services 93 provide large-scale processing using multiple interconnected computers or nodes to solve computational problems or perform tasks collectively. In distributed computing, the processing and storage capabilities of multiple machines are leveraged to work together as a unified system. Distributed computing services are designed to address problems that cannot be efficiently solved by a single computer or that require large-scale computational power or support for highly dynamic compute, transport or storage resource variance or uncertainty over time requiring scaling up and down of constituent system resources. These services enable parallel processing, fault tolerance, and scalability by distributing tasks across multiple nodes.

Although described above as a physical device, computing device 10 can be a virtual computing device, in which case the functionality of the physical components herein described, such as processors 20, system memory 30, network interfaces 40, NVLink or other GPU-to-GPU high bandwidth communications links and other like components can be provided by computer-executable instructions. Such computer-executable instructions can execute on a single physical computing device, or can be distributed across multiple physical computing devices, including being distributed across multiple physical computing devices in a dynamic manner such that the specific, physical computing devices hosting such computer-executable instructions can dynamically change over time depending upon need and availability. In the situation where computing device 10 is a virtualized device, the underlying physical computing devices hosting such a virtualized computing device can, themselves, comprise physical components analogous to those described above, and operating in a like manner. Furthermore, virtual computing devices can be utilized in multiple layers with one virtual computing device executing within the construct of another virtual computing device. Thus, computing device 10 may be either a physical computing device or a virtualized computing device within which computer-executable instructions can be executed in a manner consistent with their execution by a physical computing device. Similarly, terms referring to physical components of the computing device, as utilized herein, mean either those physical components or virtualizations thereof performing the same or equivalent functions.

The skilled person will be aware of a range of possible modifications of the various aspects described above. Accordingly, the present invention is defined by the claims and their equivalents.

What is claimed is:

1. A system for identity-weighted access token generation and capability-aware delivery, comprising:
a mobile computing device comprising at least a first plurality of programming instructions stored in the memory of, and operating on at least one processor of, a first computing device, wherein the first plurality of programming instructions, when operating on the at least one processor, cause the first computing device to:
interact with a near-field communication beacon or quick-response code initiator;
transmit an auto-populated text message comprising a payload, an initiator identifier, and a phone number; and
receive an identity-weighted access token via a messaging protocol;
an interaction control server comprising at least a second plurality of programming instructions stored in the memory of, and operating on at least one processor of, a second computing device, wherein the second plurality of programming instructions, when operating on the at least one processor, cause the second computing device to:
receive the transmitted text message comprising the phone number;
query a phone-number identity database using the phone number as a primary key;
retrieve an accumulated identity profile comprising interaction history and prior verification events if an existing profile is found, or initialize a new identity profile anchored to the phone number if no existing profile is found;
apply inference logic to the identity profile to compute an identity confidence score reflecting depth and quality of verification history;
evaluate a current opt-in state using a state machine comprising multiple discrete states governing messaging eligibility and access privilege levels;
dynamically adjust token entropy and privilege level parameters based on the identity confidence score;
generate the identity-weighted access token comprising a dynamically generated URL with adjusted entropic values and the adjusted privilege level;
write an enriched entry to a distributed ledger comprising the generated token, the identity confidence score, a messaging protocol identifier, and the opt-in state; and
transmit the identity-weighted access token to a messaging gateway for delivery to the mobile computing device; and
a messaging gateway comprising at least a third plurality of programming instructions stored in the memory of, and operating on at least one processor of, a third computing device, wherein the third plurality of programming instructions, when operating on the at least one processor, cause the third computing device to:
query a Rich Communication Services (RCS) capability endpoint using the phone number;
receive a capability response indicating RCS support status;
determine messaging protocol eligibility based on the opt-in state and the capability response; and
deliver the identity-weighted access token to the mobile computing device using a selected messaging protocol.

2. The system of claim 1, wherein the interaction control server further comprises an identity management service configured to maintain the phone-number identity database, to merge contextual data from each interaction into the accumulated identity profile, and to provide the updated identity profile to a trust scoring engine, and wherein the trust scoring engine is configured to apply behavioral analysis to the accumulated identity data, to evaluate consistency of device associations and behavioral patterns across time, and to incorporate loyalty status information from a loyalty management server into the identity confidence score computation.

3. The system of claim 1, wherein the interaction control server further comprises an opt-in state manager configured to capture opt-in events triggered by user interactions with digital activation assets, to maintain opt-in state information.

4. The system of claim 1, further comprising a channel eligibility service configured to coordinate with the messaging gateway to negotiate RCS capabilities, to evaluate channel eligibility based on the opt-in state and device capabilities, and to select a messaging protocol from among RCS, Short Message Service (SMS), and Multimedia Messaging Service (MMS).

5. The system of claim 1, further comprising an RCS platform interface configured to communicate with external RCS platform services and to retrieve capability profiles indicating supported RCS features comprising rich cards, interactive buttons, and branded sender identity, a capability cache configured to store the capability profiles for reuse in subsequent interactions, an RCS token renderer configured to format the identity-weighted access token for Rich Communication Services delivery with rich card layout and interactive activation button, and an SMS/MMS fallback renderer configured to reformat the identity-weighted access token for SMS or MMS delivery by converting rich layouts to plain text and replacing interactive buttons with numbered reply options.

6. The system of claim 5, further comprising a session ID continuity service configured to associate a session identifier with outbound token delivery, to maintain the session identifier across protocol transitions from RCS to SMS or MMS, and to match user responses received via different messaging protocols to an existing session using the session identifier.

7. The system of claim 1, further comprising an event host configured to receive a tiered status notification from the interaction control server indicating the adjusted privilege level, to receive an activation signal from the mobile computing device upon user activation of the identity-weighted access token, and to provide differentiated access to a controlled physical location based on the adjusted privilege level.

8. The system of claim 1, wherein the enriched entry written to the distributed ledger further comprises a loyalty tier and a timestamp, creating an auditable trust evolution record that documents identity confidence progression across multiple verification events.

9. The system of claim 6, wherein the interaction control server is further configured to retrieve session state and token lineage using the session identifier upon receiving a delivery failure notification from the messaging gateway, to automatically reformat the identity-weighted access token for SMS or MMS delivery while maintaining the session identifier, and to preserve complete session history across protocol transitions.

10. The system of claim 1, wherein the interaction control server is further configured to obtain device-specific data comprising carrier billing information, hardware identifiers, and location data from the mobile computing device, and to incorporate the device-specific data into the identity profile.

11. A method for identity-weighted access token generation and capability-aware delivery, comprising the steps of:
interacting with a near-field communication beacon or quick-response code initiator, using a mobile computing device;
transmitting an auto-populated text message comprising a payload, an initiator identifier, and a phone number, using a mobile computing device;
receiving an identity-weighted access token via a messaging protocol, using a mobile computing device;
receiving the transmitted text message comprising the phone number, using an interaction control server;
querying a phone-number identity database using the phone number as a primary key, using an interaction control server;
retrieving an accumulated identity profile comprising interaction history and prior verification events if an existing profile is found, or initialize a new identity profile anchored to the phone number if no existing profile is found, using an interaction control server;
applying inference logic to the identity profile to compute an identity confidence score reflecting depth and quality of verification history, using an interaction control server;
evaluating a current opt-in state using a state machine comprising multiple discrete states governing messaging eligibility and access privilege levels, using an interaction control server;
dynamically adjusting token entropy and privilege level parameters based on the identity confidence score, using an interaction control server;
generating the identity-weighted access token comprising a dynamically generated URL with adjusted entropic values and the adjusted privilege level, using an interaction control server;
writing an enriched entry to a distributed ledger comprising the generated token, the identity confidence score, a messaging protocol identifier, and the opt-in state, using an interaction control server;
transmitting the identity-weighted access token to a messaging gateway for delivery to the mobile computing device, using an interaction control server;
querying a Rich Communication Services (RCS) capability endpoint using the phone number, using a messaging gateway;
receiving a capability response indicating RCS support status, using a messaging gateway;
determining messaging protocol eligibility based on the opt-in state and the capability response, using a messaging gateway; and
delivering the identity-weighted access token to the mobile computing device using a selected messaging protocol, using a messaging gateway.

12. The method of claim 11, further comprising the steps of:
maintaining the phone-number identity database, merging contextual data from each interaction into the accumulated identity profile, and providing the updated identity profile to a trust scoring engine, using an identity management service; and
applying behavioral analysis to the accumulated identity data, evaluating consistency of device associations and behavioral patterns across time, and incorporating loyalty status information from a loyalty management server into the identity confidence score computation, using a trust scoring engine.

13. The method of claim 11, further comprising the step of capturing opt-in events triggered by user interactions with digital activation assets, maintaining opt-in state information using a state machine.

14. The method of claim 11, further comprising the steps of:
coordinating with the messaging gateway to negotiate RCS capabilities, using a channel eligibility service;
evaluating channel eligibility based on the opt-in state and device capabilities, using a channel eligibility service; and
selecting a messaging protocol from among RCS, Short Message Service (SMS), and Multimedia Messaging Service (MMS), using a channel eligibility service.

15. The method of claim 11, further comprising the steps of:
communicating with external RCS platform services and retrieving capability profiles indicating supported RCS features comprising rich cards, interactive buttons, and branded sender identity, using an RCS platform interface;
storing the capability profiles for reuse in subsequent interactions, using a capability cache;
formatting the identity-weighted access token for RCS delivery with rich card layout and interactive activation button, using an RCS token renderer; and
reformatting the identity-weighted access token for SMS or MMS delivery by converting rich layouts to plain text and replacing interactive buttons with numbered reply options, using an SMS/MMS fallback renderer.

16. The method of claim 15, further comprising the steps of:
associating a session identifier with outbound token delivery;
maintaining the session identifier across protocol transitions from RCS to SMS or MMS; and
matching user responses received via different messaging protocols to an existing session using the session identifier, using a session ID continuity service.

17. The method of claim 11, further comprising the steps of:
receiving a tiered status notification from the interaction control server indicating the adjusted privilege level, using an event host;
receiving an activation signal from the mobile computing device upon user activation of the identity-weighted access token, using an event host; and
providing differentiated access to a controlled physical location based on the adjusted privilege level, using an event host.

18. The method of claim 11, wherein the enriched entry written to the distributed ledger further comprises a loyalty tier and a timestamp, creating an auditable trust evolution record that documents identity confidence progression across multiple verification events.

19. The method of claim 16, further comprising the steps of:
retrieving session state and token lineage using the session identifier upon receiving a delivery failure notification from the messaging gateway, using an interaction control server;
automatically reformatting the identity-weighted access token for SMS or MMS delivery while maintaining the session identifier, using an interaction control server; and
preserving complete session history across protocol transitions, using an interaction control server.

20. The method of claim 11, further comprising the steps of:
obtaining device-specific data comprising carrier billing information, hardware identifiers, and location data from a mobile computing device; and
incorporating the device-specific data into the identity profile, using an interaction control server.
